(19) United States
(12) Patent Application Publication
(10) Pub. No.: US 2014/0306992 A1
(43) Pub. Date: Oct. 16, 2014

(54) IMAGE PROCESSING APPARATUS, IMAGE PROCESSING SYSTEM AND IMAGE PROCESSING METHOD

(71) Applicant: CANON KABUSHIKI KAISHA, Tokyo (JP)

(72) Inventors: Takuya Tsujimoto, Kawasaki-shi (JP); Masanori Sato, Yokohama-shi (JP); Tomohiko Takayama, Tokyo (JP)

(21) Appl. No.: 14/356,213

(22) PCT Filed: Dec. 11, 2012
(86) PCT No.: PCT/JP2012/007916

§ 371 Date: May 5, 2014

(30) Foreign Application Priority Data
Dec. 26, 2011 (JP) 2011-283722
Dec. 27, 2011 (JP) 2011-286782
Oct. 11, 2012 (JP) 2012-225979

(51) Int. Cl. G06T 11/60

(52) U.S. Cl. CPC G06T 11/60
USPC 345/632

(57) ABSTRACT

An image processing apparatus includes: an attaching unit that attaches an annotation to a diagnostic image acquired by imaging an object; a recording unit that records, in a storing unit along with an annotation, attribute information which is information on a predetermined attribute, as information related to the annotation; a searching unit that searches a plurality of positions where annotations are attached respectively in the diagnostic image, for a target position which is a position a user has an interest in; and a displaying unit that displays the search result by the searching unit on a display. The searching unit searches for the target position using a word included in the annotation or the attribute information as a key.

### TECHNICAL FIELD

The present invention relates to an image processing apparatus, an image processing system, an image processing method and a program.

### BACKGROUND ART

Recently in the field of pathology, a virtual slide system is receiving attention as an alternative to an optical microscope which is a tool of pathological diagnosis, and the virtual slide system allows pathological diagnosis on a display by imaging a test sample (test object) placed on a slide, and digitizing the image. Digitizing a pathological diagnostic image using a virtual slide system makes it possible to handle an optical microscopic image of test data as digital image data. Therefore the virtual slide system is expected to generate such merits as quicker remote diagnosis, making it possible to explain to a patient using a digital image, sharing rare cases, and more efficient education and training.

In order to implement a virtual slide system that can perform operation at an equivalent level as an optical microscope, an image of an entire test object on a slide must be digitized. If the image of the entire test object is digitized, the entire test object can be observed using viewer software (viewer) which runs on a PC (Personal Computer) or workstation. Normally the number of pixels to digitize an image of an entire test object is enormous, hundreds of millions to billions of pixels. Thus the data volume of digitized image data generated by the virtual slide system is enormous. However this data allows observation from the micro (enlarged detailed image) to the macro (an entire bird's eye view) level by zooming in or zoom out on an image using viewer software, and can provide various conveniences. If all the necessary information is acquired in advance, an image at the resolution and magnification desired by the user can be displayed immediately. For example, images from low magnification to high magnification can be displayed immediately.

Further, an image processing apparatus that attaches an annotation to a medical image (ultrasonic image) when the medical image is acquired and that searches the medical image using a comment in the annotation as a search key has been proposed (Patent Literature 1).

### CITATION LIST

Patent Literature
PTL 1: Japanese Patent Application Laid-Open No. H11-353327

### SUMMARY OF INVENTION

### Technical Problem

In such a diagnostic image as a virtual slide image, there are many locations that the diagnostician has interests in (target position, target region, region of interest) compared with other medical images. If only a comment is attached as an annotation to search for these target positions, the detection of target positions is limited because comments limit the search targets. And if target positions are searched for by checking all the attached annotations, on the other hand, it takes time for the diagnostician (pathologist) to perform diagnosis.

With the foregoing in view, it is an object of the present invention to provide a technology that allows a user to detect a target position efficiently, and to save time in diagnosis.

### Solution to Problem

The present invention in its first aspect provides an image processing apparatus, including: an attaching unit that attaches an annotation to a diagnostic image acquired by imaging an object; a recording unit that records, in a storing unit along with an annotation, attribute information which is information on a predetermined attribute, as information related to the annotation; a searching unit that searches a plurality of positions where annotations are attached respectively in the diagnostic image, for a target position which is a position a user has an interest in; and a displaying unit that displays the search result by the searching unit on a display, wherein the searching unit searches for the target position using a word included in the annotation or the attribute information as a key.

The present invention in its second aspect provides an image processing system, including: the image processing apparatus according to the present invention; and the display.

The present invention in its third aspect provides an image processing method including: an attaching step in which a computer attaches an annotation to a diagnostic image acquired by imaging an object; a recording step in which the computer records, in a storing unit along with an annotation, attribute information which is information on a predetermined attribute, as information related to the annotation; a searching step in which the computer searches a plurality of positions where annotations are attached respectively in the diagnostic image, for a target position which is a position a user has an interest in; and a displaying step in which the computer displays the search result obtained in the searching step on a display, wherein the target position is searched for in the searching step, using a word included in the annotation or the attribute information as a key.

The present invention in its fourth aspect provides a program (or a non-transitory computer readable medium recording a program) that causes a computer to execute each step of the image processing method according to the present invention.

According to the present invention, a user can detect a target position efficiently and save time in diagnosis.

Further features of the present invention will become apparent from the following description of exemplary embodiments with reference to the attached drawings.

### BRIEF DESCRIPTION OF DRAWINGS

FIG. 1 is a diagram depicting a configuration of an image processing system according to Embodiment 1.

FIG. 2 is a block diagram depicting a functional configuration of an imaging apparatus according to Embodiment 1.

FIG. 3 is a block diagram depicting a functional configuration of an image processing apparatus according to Embodiment 1.

FIG. 4 is a block diagram depicting a hardware configuration of the image processing apparatus according to Embodiment 1.

FIG. 5 is a conceptual diagram depicting a hierarchical image provided for each magnification in advance.

FIG. 6 is a flow chart depicting a general processing flow of the image processing apparatus according to Embodiment 1.

FIG. 7 is a flow chart depicting annotation attachment processing according to Embodiment 1.

FIG. 8 is a flow chart depicting target position searching processing according to Embodiment 1.

FIG. 9A is a part of a flow chart depicting search result display processing according to Embodiment 1.

FIG. 9B is the rest of the flow chart of FIG. 9A.

FIG. 10A is an example of a display image according to Embodiment 1.

FIG. 10B is an example of a display image according to Embodiment 1.

FIG. 10C is an example of a display image according to Embodiment 1.

FIG. 10D is an example of a display image according to Embodiment 1.

FIG. 10E is an example of a display image according to Embodiment 1.

FIG. 11 is an example of a configuration of an annotation list.

FIG. 12 is a diagram depicting a configuration of an image processing system according to Embodiment 2.

FIG. 13A is a flow chart depicting search result display processing according to Embodiment 2.

FIG. 13B is the rest of the flow chart of FIG. 13A.

FIG. 14A is an example of a display image according to Embodiment 2.

FIG. 14B is an example of a display image according to Embodiment 2.

FIG. 14C is an example of a display image according to Embodiment 2.

FIGS. 15A and 15B are an example of a diagnostic criterion setting screen and a diagnostic classification screen according to Embodiment 1.

FIG. 16 is an example of a diagnostic support data list.

### DESCRIPTION OF EMBODIMENTS

### Embodiment 1

An image processing system according to Embodiment 1 of the present invention will now be described with reference to the drawings.

An image processing apparatus according to Embodiment 1 of the present invention can be used for an image processing system comprising an imaging apparatus and a display apparatus.

(Apparatus Configuration of Image Processing System)

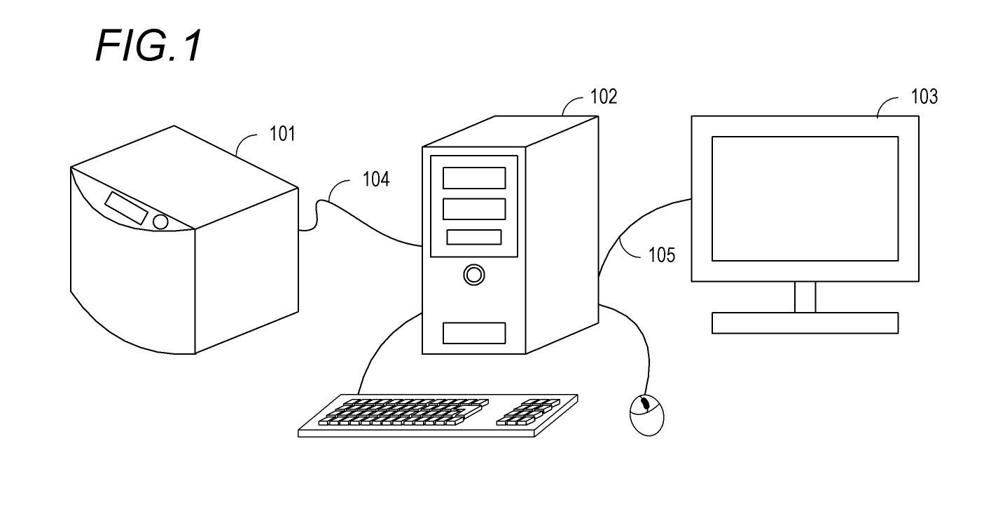

The image processing system according to this embodiment will be described with reference to FIG. 1.

FIG. 1 is a diagram depicting a configuration of the image processing system using the image processing apparatus according to this embodiment. The image processing system according to this embodiment comprises an imaging apparatus (microscope apparatus or virtual slide scanner) 101, an image processing apparatus 102 and a display apparatus 103, and has the functions to acquire and display a two-dimensional image of an imaging target test object (test sample). The imaging apparatus 101 and the image processing apparatus 102 are interconnected via a dedicated or standard I/F cable 104, and the image processing apparatus 102 and the display apparatus 103 are interconnected via a standard I/F cable 105.

For the imaging apparatus 101, a virtual slide apparatus, which images a plurality of two-dimensional images in different locations in the two-dimensional direction and outputs a digital image, can be used for example. A solid-state image sensing device, such as a CCD (Charge Coupled Device) and CMOS (Complementary Metal Oxide Semiconductor) is used to acquire the two-dimensional images. For the imaging device 101, a digital microscope apparatus, where a digital camera is installed in an eye piece of an ordinary optical microscope, may be used.

The image processing apparatus 102 has a function to generate data to be displayed on the display apparatus 103 (display data) from digital image data acquired from the imaging apparatus 101 (original image data) according to the request by the user. The image processing apparatus 102 is a standard computer or workstation comprising such hardware resources as a CPU (Central Processing Unit), a RAM, a storage device and various I/Fs including an operation unit. The storage device is a large capacity information storage device, such as a hard disk drive, which stores programs and data to implement each processing to be described later, and an OS (Operating System). Each function of the image processing apparatus 102 is implemented by the CPU loading required programs and data from the storage device to the RAM, and executing the programs. The operation unit is a keyboard or a mouse, and is used for the user to input various instructions.

The display apparatus 103 is a display (display unit) that displays images based on display data, which is a result of the processing performed by the image processing apparatus 102. A display device using EL (Electro-Luminescence), liquid crystals or a CRT (Cathode Ray Tube) can be used for the display apparatus 103.

In the example in FIG. 1, the image processing system is constituted by three apparatuses: the imaging apparatus 101; the image processing apparatus 102; and the display apparatus 103, but the configuration of the present invention is not limited to this configuration. For example, the image processing apparatus may be integrated with the display apparatus, or the functions of the image processing apparatus may be built in to the imaging apparatus. The functions of the imaging apparatus, the image processing apparatus and the display apparatus may be implemented by one apparatus. Also the functions of one apparatus may be implemented by a plurality of apparatuses. For example, the functions of the image processing apparatus may be implemented by a plurality of apparatuses.

(Functional Configuration of Imaging Apparatus)

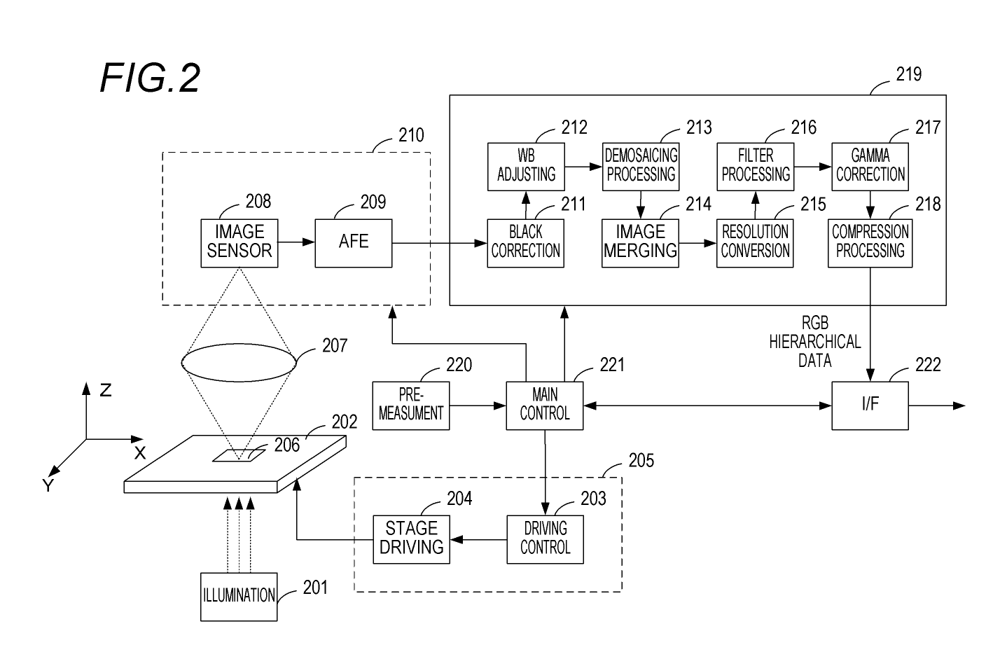

FIG. 2 is a block diagram depicting a functional configuration of the imaging apparatus 101.

The imaging apparatus 101 generally comprises an illumination unit 201, a stage 202, a stage control unit 205, an imaging optical system 207, an imaging unit 210, a development processing unit 219, a pre-measurement unit 220, a main control unit 221 and a data outputting unit 222.

The illumination unit 201 is a unit to evenly irradiate light onto a slide 206 (test object) placed on the stage 202, and is constituted by a light source, an illumination optical system and a light source drive control system. The stage 202 is drive-controlled by the stage control unit 205, and can move in three axis directions: X, Y and Z. The slide 206 is a member used by placing a test object to be observed (a slice of tissue or a cell smear) on a slide glass, and securing the test object together with an encapsulating medium under a cover glass.

The stage control unit 205 is constituted by a drive control system 203 and a stage drive mechanism 204. The drive control system 203 controls driving of the stage 202 based on the instructions received from the main control system 221. The moving direction and moving distance of the stage 202 are determined based on position information and thickness information (distance information) of the test object measured by the pre-measurement unit 217 and instructions from the user which are received as needed. The stage drive mechanism 204 drives the stage 202 according to the instructions received from the drive control system 203.

The imaging optical system 207 is a lens group for forming an optical image of the test object on the slide 206 on the image sensor 208.

The imaging unit 210 is constituted by the image sensor 208 and an analog front end (AFE) 209.

The image sensor 208 is a one-dimensional or two-dimensional image sensor for converting a two-dimensional optical image into an electric physical quantity by photoelectric conversion, and a CCD or CMOS device, for example, is used as the image sensor 208. If the image sensor 208 is a one-dimensional sensor, a two-dimensional image (a two-dimensionally captured image) is acquired by scanning a sample with the image sensor 208 in the scanning direction. An electrical signal (analog signal) having a voltage value according to the intensity of the light is outputted from the image sensor 208. If a color image is desired for the image, a single-chip image sensor, where a color filter having a Bayer array is installed, for example, is used. The imaging unit 210 captures divided images of a test object (a plurality of divided images of which imaging areas are different from one another) by the stage 202 that is driven in the X and Y axis directions.

The AFE 209 is a circuit to convert an analog signal, outputted from the image sensor 208, into a digital signal. The AFE 209 is constituted by an H/V driver, a CDS (Correlated Double Sampling) circuit, an amplifier, an AD converter and a timing generator, which will be described later. The H/V driver converts a vertical synchronization signal and a horizontal synchronization signal for driving the image sensor 208 into potential required for driving the sensor. The CDS circuit is a correlated double sampling circuit for removing noises in fixed patterns. The amplifier is an analog amplifier for adjusting the gain of an analog signal after the CDS circuit removes noises. The AD converter converts an analog signal into a digital signal. If the output in the final stage of the imaging apparatus is 8 bits, the AD converter converts an analog signal into digital data which has been quantized to about 10 bits to 16 bits, considering the processing in subsequent stages, and outputs this digital data. The converted sensor output data is called “raw” data. The raw data is developed in a development processing unit 219 in a subsequent stage. The timing generator generates a signal to adjust the processing timing of the image sensor 208 and the processing timing of the development processing unit 219 in a subsequent stage.

If a CCD is used for the image sensor 208, the AFE 209 is required, but in the case of a CMOS image sensor that can output digital data, the functions of the AFE 209 are built in to the CMOS image sensor. An imaging control unit to control the image sensor 208 is also included, although it is not illustrated, so as to control the operation of the image sensor 208, and to control shutter speed, frame rate and ROI (Region Of Interest), including operation timing.

The development unit 219 is constituted by a black correction unit 211, a white balance adjustment unit 212, a demosaicing processing unit 213, an image synthesis processing unit 214, a resolution conversion processing unit 215, a filter processing unit 216, a gamma correction unit 217 and a compression processing unit 218.

The black correction unit 211 subtracts black correction data acquired during shading from each pixel of raw data.

The white balance adjustment unit 212 adjusts the gain of each RGB color according to the color temperature of the light of the illumination unit 201, whereby the desired white color is reproduced. In concrete terms, white balance correction data is added to the raw data acquired after the black correction. White balance adjustment processing is unnecessary in the case of handling a monochrome image.

The demosaicing processing unit 213 generates image data of each RGB color from the raw data in a Bayer array. The demosaicing processing unit 213 calculates a value of each RGB color of a target pixel by interpolating values of peripheral pixels (including a pixel having a same color and a pixel having a different color) in the raw data. The demosaicing processing unit 213 also executes correction processing (interpolation processing) for a defective pixel. The demosaicing processing is not necessary if the image sensor 208 has no color filter and if a monochrome image is acquired.

The image synthesis processing unit 214 generates large capacity image data in a desired imaging range, by merging divided image data acquired by dividing the imaging range using the image sensor 208. Generally the range where a test object exists is wider than the imaging range which a conventional image sensor can capture by one imaging operation, therefore one two-dimensional image data (large capacity image data) is generated by merging divided image data. For example, if it is assumed that a 10 mm square range is imaged on a slide 206 at a 0.25 um (micrometer) resolution, the number of pixels on one side is 10 mm/0.25 um, that is 40,000 pixels, and a total number of pixels is a square thereof, that is 1.6 billion pixels. In order to acquire 1.6 billion pixels of image data using the image sensor 208 of which number of pixels is 10 M (10 million), the area must be divided as 1.6 billion/10 million, that is into 160 sub-areas for imaging. Examples of the method to merge a plurality of image data are: aligning and merging the divided images based on the position information on the stage 202; aligning and merging the divided images according to corresponding points or lines of the plurality of divided images; and merging the divided images based on the position information of the divided image data. The plurality of divided images can be smoothly merged if such interpolation processing as 0-order interpolation, linear interpolation and high-order interpolation is used. In this embodiment, it is assumed that one large capacity image is generated, but the image processing apparatus 102 may acquire a plurality of divided image data and merge the divided images when the display data is generated.

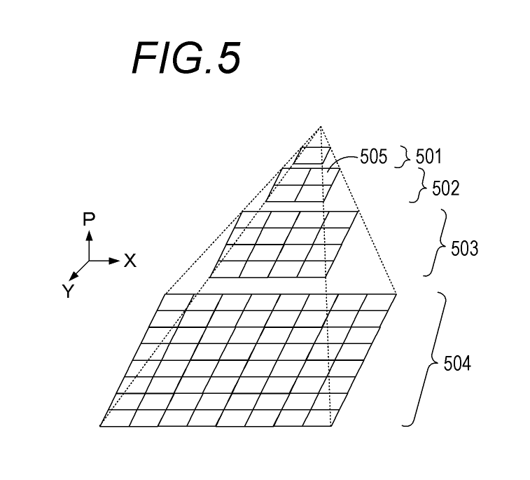

The resolution conversion processing unit 215 generates a plurality of images, of which magnification values are different from one another, by the resolution conversion in advance, so that a large capacity two-dimensional image generated by the image synthesis processing unit 214 is displayed at high-speed. The resolution conversion processing unit 215 generates image data at a plurality of magnification values, from low magnification to high magnification, and generates data having a hierarchical structure by integrating these image data. Details on data having this hierarchical structure will be described later with reference to FIG. 5.
The filter processing unit 216 is a digital filter that suppresses high frequency components included in the image, removes noises, and enhances the resolution. The gamma correction unit 217 executes processing to attach reverse characteristics to the image according to the gradation expression characteristics of a standard display device, or executes the gradation conversion according to the visual characteristics of human eyes, depending on the gradation compression in a high brightness area or on dark area processing. In this embodiment, gradation conversion suitable for synthesis processing and display processing is performed on the image data in order to acquire an image appropriate for morphological observation.
The compression processing unit 218 performs encoding processing in order to make transmission of a large capacity two-dimensional image data efficient, and to reduce (compress) the capacity of data to be stored. To compress a still image, such standardized encoding methods as JPEG (Joint Photographic Experts Group) and JPEG2000 and JPEGXR, which are improvements to JPEG, are widely known.

The pre-measurement unit 220 pre-measures the position of a test object on the slide 206, the distance up to a desired focal position, and the parameters for light quantity adjustment required due to the thickness of the test object. Acquiring information prior to actual measurement using the pre-measurement unit 220 makes it possible to execute imaging without wasteful procedures. A two-dimensional image sensor, of which resolution is lower than the image sensor 208, is used to acquire position information on the two-dimensional plane. The pre-measurement unit 220 recognizes the position of the test object on the XY plane based on the acquired image. A laser displacement gauge and a Shack-Hartman type measurement instrument are used to acquire the distance information and the thickness information.

The main control system 221 controls the various units described above. The control functions of the main control system 221 and the development processing unit 219 are implemented by a control circuit having a CPU, a ROM and a RAM. In other words, programs and data are stored in the ROM, and the CPU executes the programs using the RAM as a work memory, whereby the functions of the main control system 221 and the development processing unit 219 are implemented. Such a device as an EEPROM or a flash memory is used for the ROM, and such as DRAM device as a DDR3 is used for the RAM, for example. The main control system 221 may be replaced with an ASIC, integrating the functions of the development processing unit 219 on a dedicated hardware device.

The data output unit 222 is an interface for transmitting image data generated by the development processing unit 219 to the image processing apparatus 102 as diagnostic image data. The imaging apparatus 101 and the image processing apparatus 102 are interconnected via an optical communication cable. A standard interface, such as USB and Gigabit Ethernet (Registered Mark), may be used instead.

(Functional Configuration of Image Processing Apparatus)

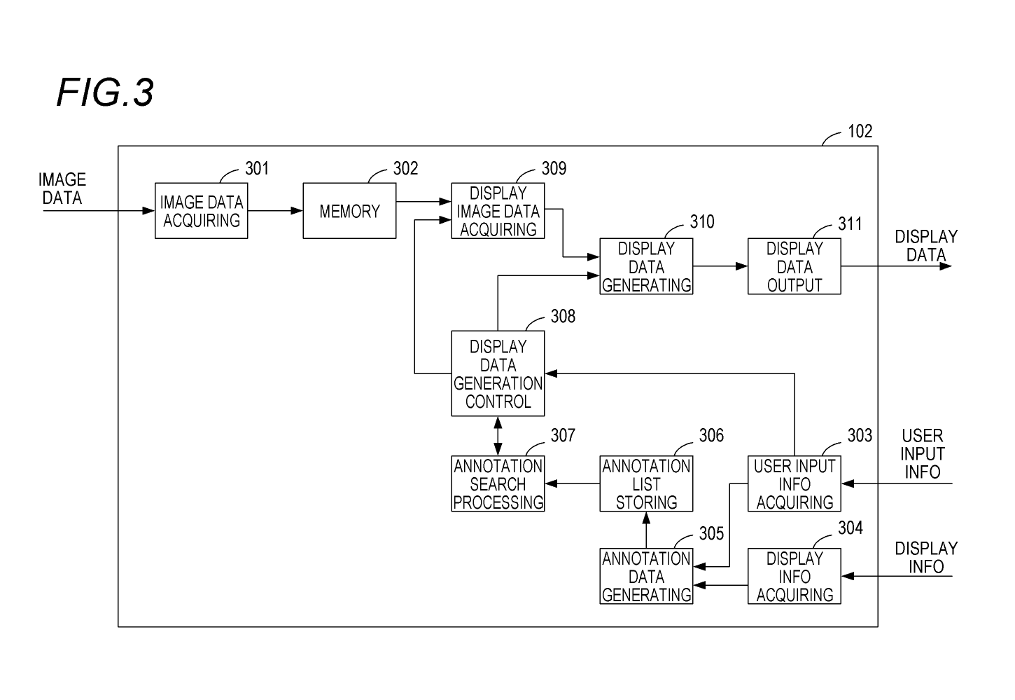

FIG. 3 is a block diagram depicting a functional configuration of the image processing apparatus 102 according to the present embodiment.

The image processing apparatus 102 generally comprises an image data acquiring unit 301, a storing unit (memory) 302, a user input information acquiring unit 303, a display apparatus information acquiring unit 304, an annotation data generating unit 305, an annotation list storing unit 306, an annotation search processing unit 307, a display data generation control unit 308, a display image data acquiring unit 309, a display data generating unit 310, and a display data output unit 311.

The image data acquiring unit 301 acquires an image data captured by the imaging apparatus 101 (data on a diagnostic image acquired by imaging a test object (image of a diagnostic target)). The diagnostic image data mentioned here is at least one of RGB color-divided image data acquired by imaging a test object in sections, single two-dimensional image data generated by merging divided image data (high resolution image data), and image data at each magnification generated based on the high resolution image data (hierarchical image data). The divided image data may be monochrome image data.

The storing unit 302 loads image data acquired from an external apparatus (imaging apparatus 101) via the image data acquiring unit 301, and stores and holds the data.

The user input information acquiring unit 303 acquires, via such an operation unit as a mouse or keyboard, an instruction to update display image data (image data on an area where a diagnostic image is displayed), such as a change of a display position in the diagnostic image, and a change of display magnification of a diagnostic image (magnification of a tomographic image to be displayed: zoom in ratio, zoom out ratio). The user input information acquiring unit 303 also acquires, via such an operation unit as a mouse or keyboard, input information to a display application that is used for attaching an annotation to a region of interest in the diagnostic image. An annotation is information that is attached to image data as a comment, and can be simple information to notify that a comment is attached, or information that includes the comment content (text data).

The display apparatus information acquiring unit 304 acquires information on display magnification of a currently displayed image (display magnification information) as well as display area information of a display of the display apparatus 103 (screen resolution).

The annotation data generating unit 305 attaches an annotation to a position of a diagnostic image according to user specification. When the annotation is attached, the annotation data generating unit 305 records not only text information as the comment content, but also attribute information as information related to the annotation, in a storing unit (annotation list storing unit 306) together with the text information. Attribute information is used for narrowing down annotations the observer (e.g. doctor, technician) should have an interest in (pay attention to), out of the many annotations attached to the diagnostic image, as mentioned later. Therefore any kind of information can be used as attribute information if the information is useful to narrow down (search) annotations. For example, information on a time when an annotation is attached or on an individual user who is attached as an annotation (an annotation is attached automatically by a computer or manually by an individual), and information on purpose, intention and viewpoint of attaching an annotation, can be used as attribute information. Details on the attribute information will be described later.

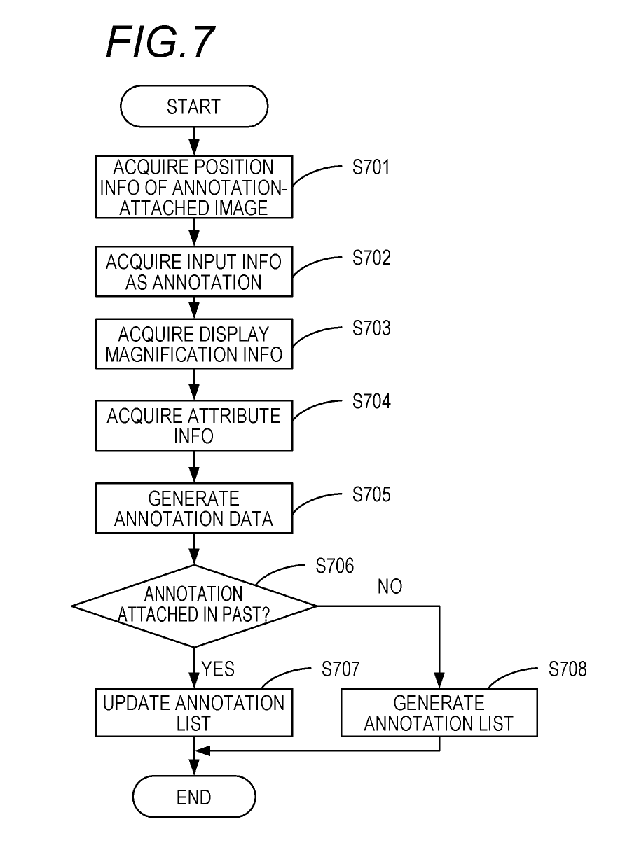

The annotation data generating unit 305 acquires information on positional coordinates (coordinates of a position specified by the user (position where the annotation is attached) on the display screen (screen of the display apparatus 103) from the user input information acquiring unit 303. The annotation data generating unit 305 acquires display magnification information from the displaying apparatus information acquiring unit 304. Using this information, the annotation data generating unit 305 converts the positional coordinates on the display screen into positional coordinates on the diagnostic image. Then the annotation data generating unit 305 generates annotation data, including text information inputted as an annotation (text data), the information on positional coordinates on the diagnostic image, the display magnification information, and the attribute information. The generated annotation data is recorded in the annotation list storing unit 306. Details on the annotation attaching processing will be described later with reference to FIG. 7.

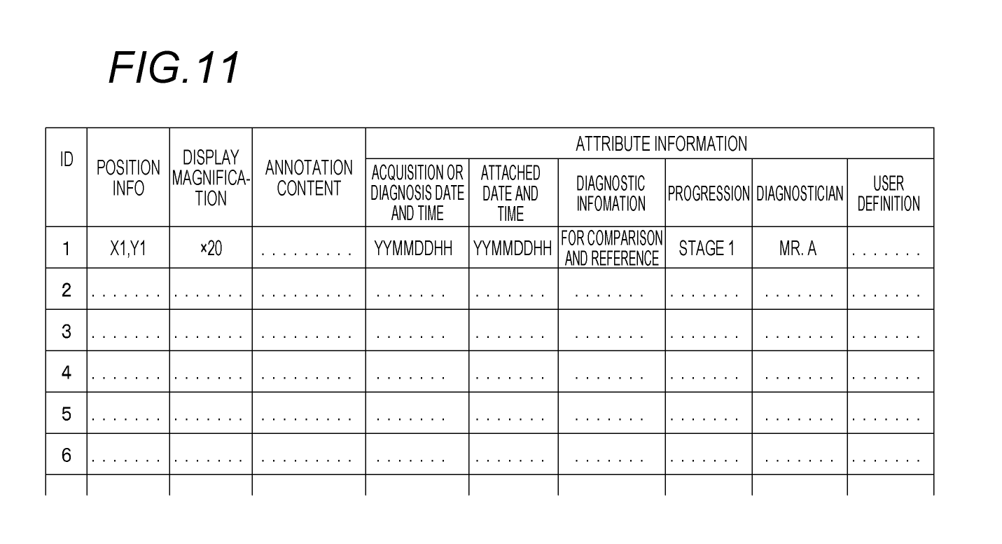

The annotation list storing unit 306 stores a reference table (annotation list) in which annotation data generated by the annotation data generating unit 305 is listed. The configuration of the annotation list will be described later with reference to FIG. 11.

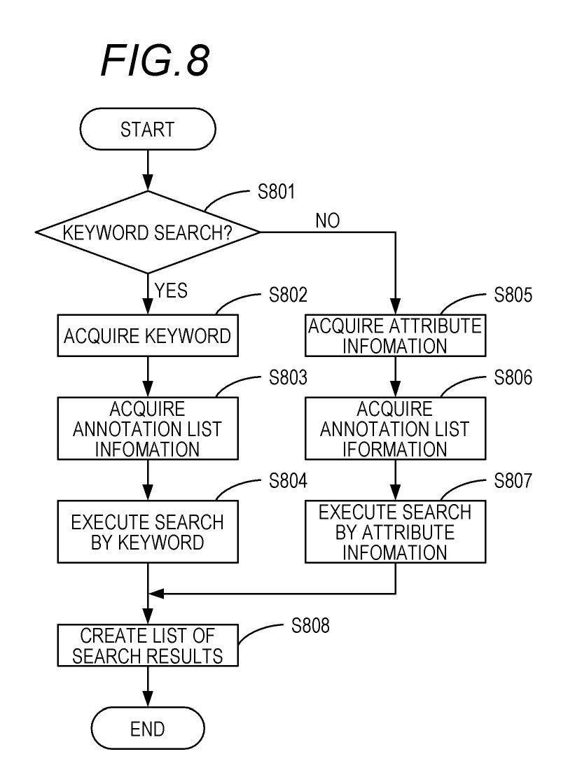

The annotation search processing unit 307 searches for a plurality of positions where an annotation is attached, for a target position which is a position that the user has an interest in. Details of the target position search processing will be described later with reference to FIG. 8.

The display data generation control unit 308 controls the generation of display data according to the instructions of the user input information acquiring unit 303. The display data is mainly constituted by display image data and annotation image data (data of an annotation image).

According to the instructions from the display data generation control unit 308, the display image data acquiring unit 309 acquires diagnostic image data required for displaying (display image data) from the storing unit 302.

The display data is generated by the display data generating unit 310 and the display data output unit 311, and is outputted to the display apparatus 103. Thereby an image based on the display data is displayed on the display apparatus 103. If a target position is searched for, the search result from the annotation search processing unit 307 is displayed on the display apparatus 103 by the display data generating unit 310 and the display data output unit 311.

In concrete terms, the display data generating unit 310 generates display data to be displayed on the display apparatus 103 using the annotation data generated by the annotation data generating unit 305 and diagnostic image data acquired by the display image data acquiring unit 309.

The display data output unit 311 outputs the display data generated by the display data generating unit 310 to the display apparatus 103, which is an external apparatus.

(Hardware Configuration of Image-Forming Apparatus)

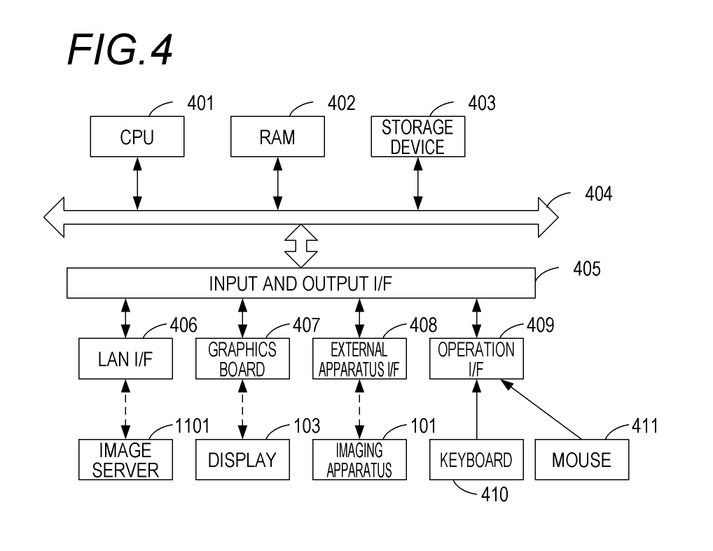

FIG. 4 is a block diagram depicting a hardware configuration of the image processing apparatus according to the present embodiment. A PC (Personal Computer), for example, is used as the image processing apparatus to perform information processing.

The PC comprises a CPU (Central Processing Unit) 401, a RAM (Random Access Memory) 402, a storage device 403 and a data input I/F 405, and an internal bus 404 that interconnects these components.

The CPU 401 accesses the RAM 402 and other components when necessary, and comprehensively controls each block of the PC while performing various operations.

The RAM 402 is used as a work area of the CPU 401, and temporarily holds the OS, various programs in-execution, and various data used for searching for an annotation and generating display data, which are characteristics of the present invention.

The storage device 403 is an auxillary storage device in which firmware, including the OS, programs and various parameters for the CPU 401 to execute, are permanently stored. For the storage device 403, a magnetic disk drive, such as an HDD (Hard Disk Drive) or a semiconductor device (e.g. SSD (Solid State Disk)) using flash memory, is used.
To the data input/output I/F 405, an image server 1101 is connected via a LAN I/F 406, the display apparatus 103 is connected via a graphics board 407, the imaging apparatus 101, such as a virtual slide apparatus and a digital microscope, is connected via an external apparatus I/F 408, and a keyboard 410 and mouse 411 are connected via the operation I/F 409.

In the present embodiment, a PC in which the display apparatus 103 is connected as an external apparatus is assumed, but the display apparatus may be integrated with the PC. A notebook PC, for example, is such a PC.

In the present embodiment, it is assumed that the keyboard 410 and a pointing device, such as the mouse 411, are used as the input devices connected via the operation I/F 409, but if the screen of the display apparatus 103 is a touch panel, then this touch panel may be used as the input device. In this case, the touch panel could be integrated with the display apparatus 103.

(Concept of Data Layered for Each Magnification)

As described above, data layered for each magnification may be input to the image to the image processing apparatus 102. FIG. 5 is a conceptual diagram depicting images provided for each magnification in advance (hierarchical images: images generated by the resolution conversion processing unit 215 of the imaging apparatus 101).

The hierarchical images have two-dimensional axes: an X axis and a Y axis. A P axis, which is orthogonal to the X axis and the Y axis, is an axis used for showing a plurality of hierarchical images in a pyramid format.

The reference numerals 501, 502, 503 and 504 denote two-dimensional images (hierarchical images) of which magnification values are different from one another, and resolution values are different from one another. To simplify description, the resolution in each one-dimensional direction (X direction or Y direction) of the hierarchical image 503 is ½ that of the hierarchical image 504. The resolution of each one-dimensional direction of the hierarchical image 502 is ½ that of the hierarchical image 503. The resolution in each one-dimensional direction of the hierarchical image 501 is ½ that of the hierarchical image 502.

The reference numeral 505 denotes an area having a size of a divided image.

For the purpose of diagnosis, it is desirable that the image data acquired by the imaging apparatus 101 is high definition and high resolution image data. However, in the case of displaying a reduced image of image data having billions of pixels, as mentioned above, processing takes too much time if resolution is converted every time display is requested. Therefore it is preferable to provide in advance a plurality of hierarchical images of which magnification values are different from one another, select an image of which magnification is close to the display magnification from the provided hierarchical images, and perform resolution conversion of the image selected according to the display magnification. Thereby the processing volume of resolution conversion can be decreased. Generally it is preferable, in terms of image quality, to generate an image at the display magnification from an image at higher magnification.

Since the image data acquired by imaging is high resolution image data, a hierarchical image data having a different magnification is generated by reducing this image data by a resolution conversion method. The known resolution methods are: a bi-linear method which is two-dimensional linear interpolation processing, and a bi-cubic method which uses a third order interpolation formula.

In the case of diagnosing and observing a diagnostic image with changing the display magnification like this, it is preferable to provide, as diagnostic image data, a plurality of hierarchical image data of which magnification values are different from one another, as shown in the drawing. A plurality of hierarchical image data may be integrated and handled as one data (file) or each hierarchical image data may be provided as independent image data, and information to indicate the relationship of the magnification and the image data may be provided.

(How to Attach an Annotation, Search for a Target Position and Display a Search Result)

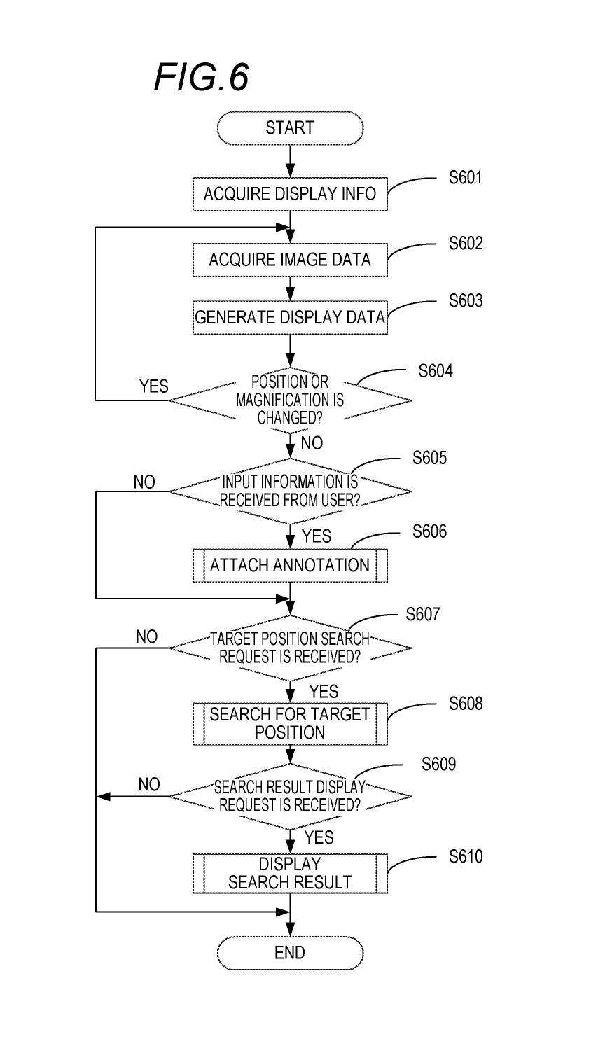

A flow of attaching an annotation, searching for a target position and displaying a search result using the image processing apparatus according to the present embodiment will be described with reference to the flow chart in FIG. 6.

In step S601, the display apparatus information acquiring unit 304 acquires the size information (screen resolution) of the display area (screen) of the display apparatus 103, and the information on magnification of a currently displayed diagnostic image (display magnification information). The display area size information is used to determine a size of the display data to be generated. The display magnification is used to select a hierarchical image and to generate annotation data. The generation of annotation data will be described later.

In step S602, the display image data acquiring unit 309 acquires diagnostic image data corresponding to the display magnification acquired in step S601 from the storing unit 302. In concrete terms, the display image data acquiring unit 309 acquires diagnostic image data at a magnification closest to the display magnification acquired in step S601 (or a magnification higher than the display magnification and closest to the display magnification) from the storing unit 302. If the diagnostic image is not displayed, the display image data acquiring unit 309 acquires diagnostic image data corresponding to a predetermined display magnification (initial value) from the storing unit 302.

In step S603, the display data generating unit 310 generates display data using the diagnostic image data acquired in step S602. In concrete terms, if the display magnification is equal to the magnification of the diagnostic image data acquired in step S602, the display data generating unit 310 generates the display data using the acquired diagnostic image data as is. If the display magnification is different from the magnification of the diagnostic image data acquired in step S602, then the display data generating unit 310 converts the resolution of the acquired diagnostic image data so that the magnification becomes the display magnification, and generates the display data using this image data of which resolution was converted. The generated display data is displayed on the display apparatus 103. In this case, if the position to be displayed in the diagnostic image (display position) is instructed, the display data is generated by extracting a part or all of the diagnostic image data at the display magnification, so that this position of the diagnostic image is displayed at the display magnification.

In step S604, the user input information acquiring unit 303 determines whether the user instructed to update the display image data. In concrete terms, it is determined that the user instructed to change the display area of the diagnostic image, such as a change of the display position and a change of the display magnification. If an update of the display image data is instructed, processing returns to step S602, where the diagnostic image data is acquired, and the screen is updated (display image is updated) by generating the display data. If an update of the display image data is not instructed, processing returns to step S605.

In step S605, the user input information acquiring unit 303 determines whether an instruction or request to attach an annotation is received from the user. If attaching an annotation is instructed, processing advances to step S606. If attaching an annotation is not instructed, the annotation attaching processing is skipped, and processing advances to step S607. For example, if the user specifies a position to attach an annotation, the user input information acquiring unit 303 determines that attaching an annotation is instructed.

In step S606, various types of processing for attaching the annotation are performed. The processing content includes acquiring text data inputted via the keyboard 410 or the like as an annotation, and acquiring attribute information, which is a characteristic of this embodiment. Details on step S606 will be described with reference to FIG. 7.

In step S607, the user input information acquiring unit 303 determines whether an instruction or request to search for a target position is received from the user. If searching for the target position is instructed, processing advances to step S608. If searching for the target position is not instructed, processing ends.

In step S608, various types of processing for searching for the target position are performed. In this step, the target position is searched for, using a word or attribute information included in the annotation as a key. In concrete terms, in the search of the target position, a candidate position, which is a candidate of the target position, is detected from a plurality of positions where the annotation is attached. Details on the processing in step S608 will be described with reference to FIG. 8. If no position is detected as a result of the search, an image or a message indicating that there is no position corresponding to the inputted key is displayed on the display apparatus 103 as the search result by the display data generating unit 310 and the display data output unit 311.

In step S609, the user input information acquiring unit 303 determines whether an instruction or request to display the result of searching for the target position is received from the user. If displaying the search result is instructed, processing advances to step S610. If displaying the search result is not instructed, processing ends.

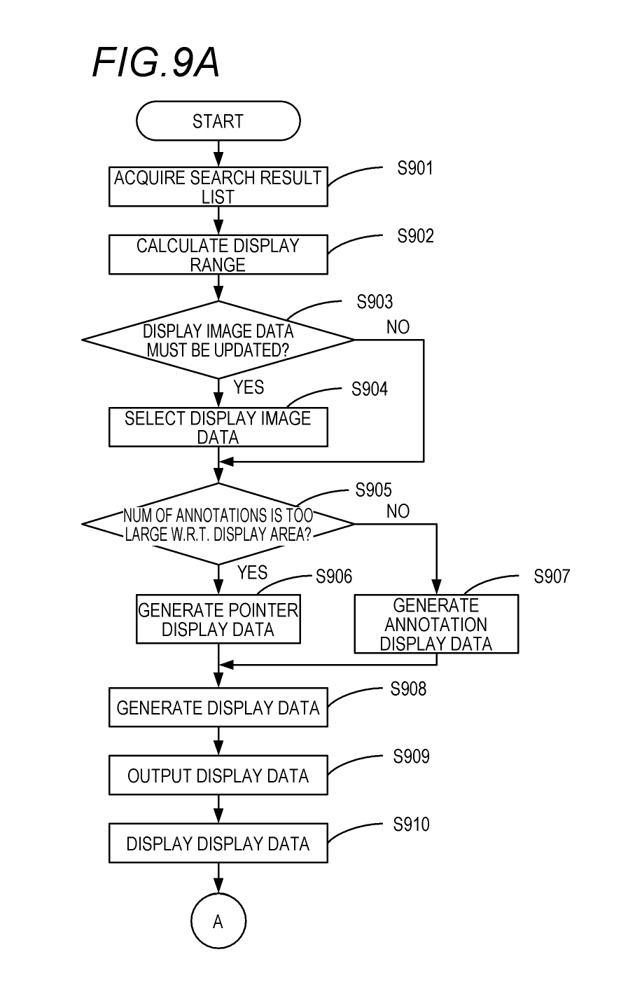

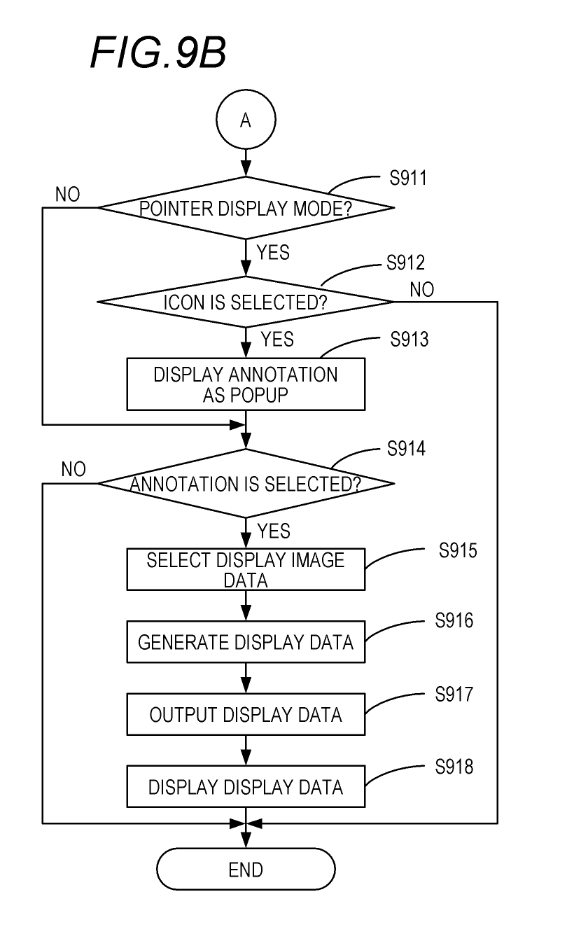

In step S610, processing to display the search result is executed. Details on the processing in step S610 will be described later with reference to FIG. 9.

FIG. 6 shows a case when accepting the screen update request, which is a request to change the display position or the display magnification, attaching the annotation, and searching for the target position are sequentially performed, but a timing of each processing is not limited to this example. These processing steps may be executed simultaneously, or may be executed at any timing without adhering to the sequence in FIG. 6.

(Attaching Annotation)

FIG. 7 is a flow chart depicting a detailed flow of processing to attach an annotation shown in step S606 in FIG. 6. Now the flow of processing to generate the annotation data based on the position where the annotation is attached, on the display magnification and on the attribute information will be described with reference to FIG. 7.

In step S701, the annotation data generating unit 305 acquires information on positional coordinates (coordinates of a position specified by the user where the annotation is attached) from the user input information acquiring unit 303. The information acquired here is information on a position (relative position) on the display screen of the display apparatus 103, so the annotation data generating unit 305 converts the position represented by the acquired information into a position (absolute position) in the diagnostic image held in the storing unit 302.

In step S702, the annotation data generating unit 305 acquires text data (annotation), which the user inputted using the keyboard 410, from the user input information acquiring unit 303. If attaching the annotation is instructed, an image to prompt the user to input text (comment) is displayed, and the user inputs the text information as the annotation content, according to the display of the image.

In step S703, the annotation data generating unit 305 acquires information on the current (time when attaching the annotation is instructed) display magnification from the display apparatus information acquiring unit 304. Here the display magnification information is acquired from the display apparatus 103, but data on the display magnification internally held may be used, since the image processing apparatus 102 generates the display data.

In step S704, the annotation data generating unit 305 acquires various attribute information to make it easier for the user to search for an annotation. In a wide sense, the position information converted in step S701 and the display magnification acquired in step S702 are included in attribute information. While the position information and the display magnification are information to indicate the observation state when the annotation is attached, the attribute information acquired in step S704 is information reflecting the environment and the intension of the user when physiological diagnosis is performed.

In concrete terms, the attribute information includes date and time information, user information, diagnostic information, and diagnostic criterion information.

The date and time information indicates a date and time when the corresponding annotation was attached, for example, and a date and time when attaching the annotation was instructed, or a date and time when text was inputted as the annotation are examples. The date and time information may also be a date and time when the diagnostic image was observed (diagnosed).

The user information is information to specify a user who attached the annotation, such as user name, an identifier to identify a user, and user attributes. According to the work flow in pathological diagnosis, a plurality of users (e.g. technician, pathologist, clinician, computer (automatic diagnostic software)) sequentially attach annotations to a same image for different purposes (view points, roles) or by different methods (e.g. automatic attachment based on image analysis, visual attachment). The user attribute is information to indicate a purpose (view point, role) or a method when each user attached an annotation, and possible examples of the user attribute are “pathologist”, “technician”, “clinician” and “automatic diagnosis”. If the user attribute is associated with the annotation as one of the above mentioned user information such that the search can be performed by the user attribute, then understanding the nature of each annotation information and the selection of information become easier, and a pathological diagnostic operation can be smoother in each step of the pathological diagnosis work flow.

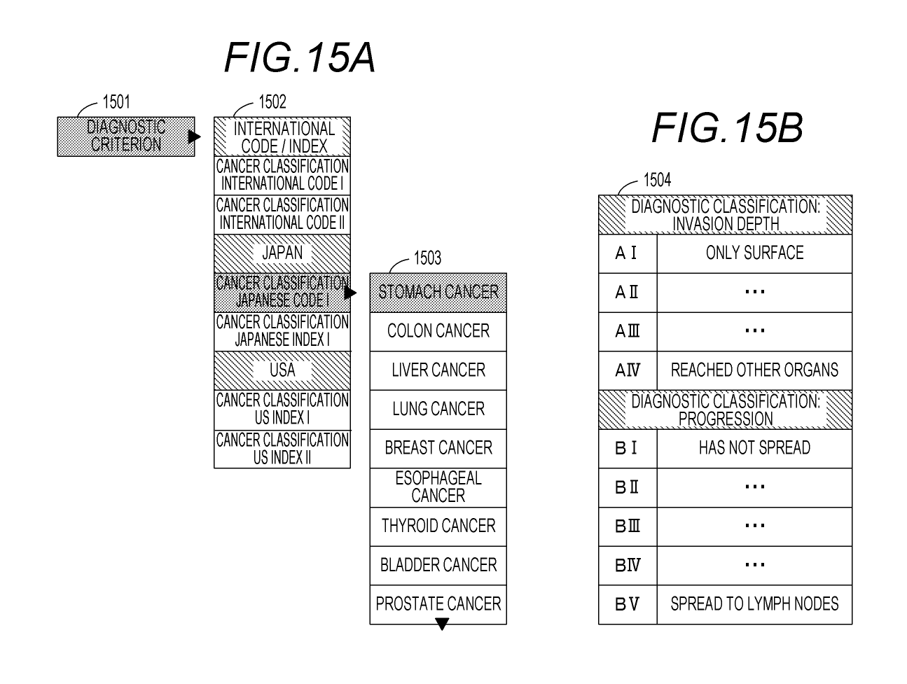

The diagnostic information is information to indicate the diagnostic content of the diagnostic image. The diagnostic information is, for example, critical information to indicate the purpose of attaching the annotation, progress of a disorder, and information on whether this diagnostic image is for comparison to make an objective (relative) observation.
The diagnostic criterion information is information summarizing the diagnostic classifications for each organ, according to the actual situation of each country and each region. The diagnostic classification indicates each stage of each organ. In the case of stomach cancer, for example, a diagnostic classification specified by cancer classification code alpha, which is a diagnostic criterion for a region, may be different from a diagnostic classification specified by a cancer classification code beta, which is a diagnostic criterion for another region. Therefore information on the diagnostic criterion and the diagnostic classification used by the user for diagnosing the diagnostic image is attached to the attribute information as diagnostic criterion information. The diagnostic criterion and diagnostic classification will be described later with reference to FIG. 15.
In this embodiment, it is assumed that the attribute information is information selected by the user from a plurality of choices (categories).
The attribute information may be automatically generated or may be inputted by the user. A part of the attribute information may be automatically generated, and other attribute information may be inputted (selected) by the user. Date and time information, for example, can be generated automatically. If attaching an annotation is instructed in the case of the user inputting the attribute information, an image to prompt the user to input attribute information is displayed, for example, and the user inputs the attribute information according to the display of this image. The input timing of the attribute information may be the same as or different from the input timing of the text of the annotation.

In step S705, data, including the information on positional coordinates converted in step S701 (information on absolute position), the text information acquired in step S702, the display magnification information acquired in step S703, and various attribute information acquired in step S704, are generated as annotation data.

The absolute positional coordinates in the diagnostic image to which annotation is attached can be converted into positional coordinates in a hierarchical image, of which magnification is different from that of the display diagnostic image when the annotation was attached, as follows. For example, it is assumed that an annotation is attached to a position of point P (100, 100), of which distance (number of pixels) in the X and Y directions from the origin of the image (X=Y=0) is 100 pixels respectively, at an ×20 display magnification. In this case, the positional coordinates where the annotation is attached is P1 (200, 200) in a high magnification image (×40). The positional coordinates where the annotation is attached is P2 (50, 50) in a low magnification image (×10). The display magnifications used here are simple values to simplify description, but if an annotation is attached to a position of point P (100, 100) at an ×25 display magnification, then the positional coordinates where the annotation is attached is P3 (160, 160) in a high magnification image (×40). By multiplying the value of the coordinates (coordinates of point P) by a ratio of the magnification of the hierarchical image and the display magnification like this, the absolute positional coordinates in the diagnostic image where the annotation is attached can be converted into positional coordinates in a hierarchical image of which magnification is different from that of the display diagnostic image when the annotation was attached. By performing this conversion, the position where the annotation is attached can be indicated even if a hierarchical image, of which magnification is different from that of the display diagnostic image when the annotation was attached, is described. In this embodiment, it is assumed that the absolute position in each hierarchical image is calculated in this step, and information on these calculated positions is included in the annotation data.

In step S706, the annotation data generating unit 305 determines whether an annotation has been attached since the diagnosis (display) of the diagnostic image started. If an annotation is attached for the first time, processing returns to step S708, and if an annotation was attached in the past even if only once, then processing advances to step S707.

In step S707, the annotation data generating unit 305 updates the annotation list created in step S708. In concrete terms, the annotation data generating unit 305 adds the annotation data created in step S705 to the currently recorded annotation list.

In step S708, the annotation data generating unit 305 generates an annotation list. In concrete terms, the annotation data generating unit 305 generates an annotation list that includes the annotation data generated in step S705. The configuration of the annotation list will be described later with reference to FIG. 11.

(Searching for Target Position)

FIG. 8 is a flow chart depicting a detailed flow of the processing to search for a target position shown in step S608 in FIG. 6. Now a flow of the processing to search for a target position based on the annotation list and to generate the search result list will be described with reference to FIG. 8.

In step S801, the annotation search processing unit 307 determines whether the target position is searched for, using a word included in the annotation as a key. If the search is performed using a word included in the annotation as a key, processing advances to step S802, and if the search is performed using attribute information as a key, processing advances to step S805.

In step S802, the annotation search processing unit 307 acquires a word (keyword), which is a search key, from the user input information acquiring unit 303. The user inputs the keyword using a keyboard, mouse or the like, or selects the keyword from past search history. The keyword is sent from the user input information acquiring unit 303 to the annotation search processing unit 307 according to the operation by the user.

In step S803, the annotation search processing unit 307 acquires text data (annotation) stored in the annotation list, which was generated or updated in step S707 or step S708.

In step S804, the annotation search processing unit 307 searches the plurality of text data acquired in step S803 using the keyword acquired in step S802. Here a standard keyword searching method, such as perfect matching with the keyword, or matching with a part of the words in the keyword can be used.

In step S805, the annotation search processing unit 307 acquires attribute information, which is a search key, from the user input information acquiring unit 303. The attribute information as a search key is selected from a plurality of choices. The attribute information as a search key may be input (selected) just like the above mentioned keyword.

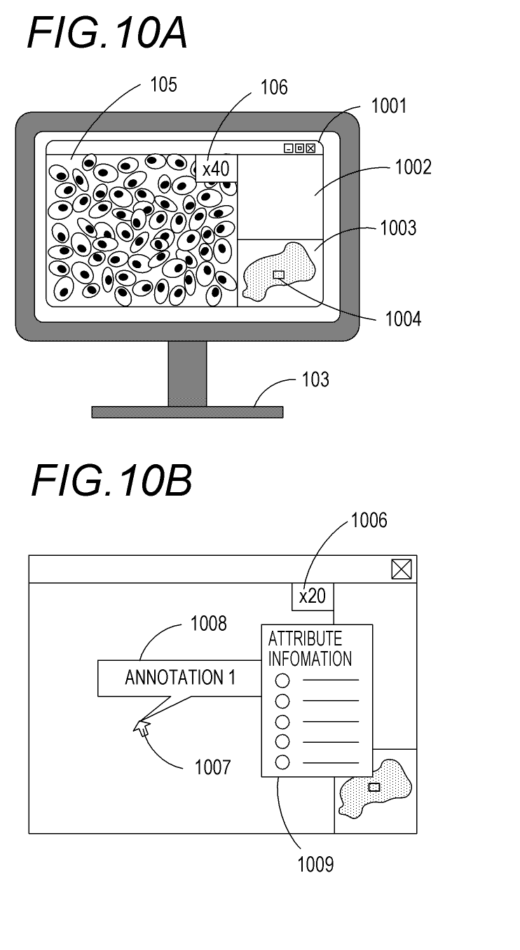

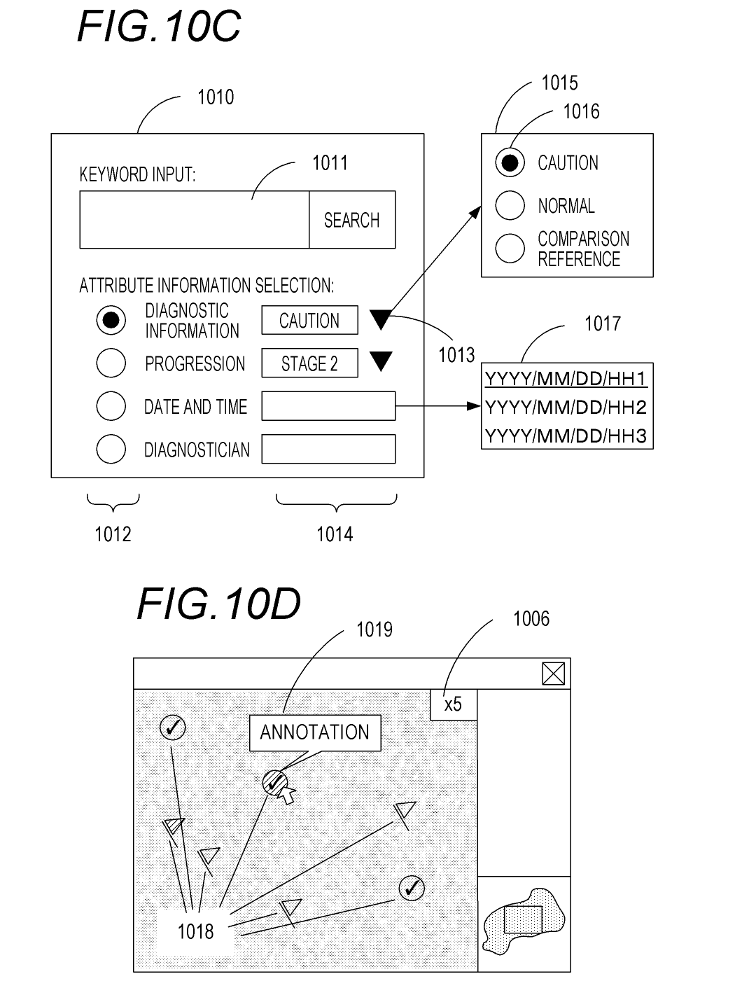

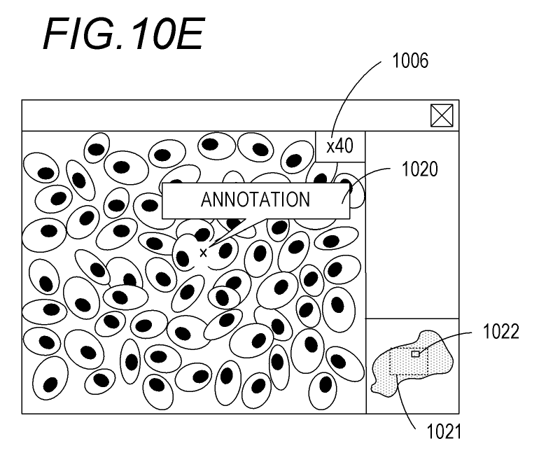

The configuration of the display image to set the search key will be described later with reference to FIG. 10.

In step S806, the annotation search processing unit 307 acquires the attribute information stored in the annotation list.

In step S807, the annotation search processing unit 307 searches the attribute information acquired in step S806 using the attribute information (search key) acquired in step S805. In the case of selecting the attribute information from a plurality of choices (categories) when an annotation is attached, a standard method, such as detecting attribute information of which category is matched with the attribute information, which is the search key, can be used.

The search methods in step S804 and step S807 are not limited to the above mentioned methods, but widely known search methods may be used according to purpose.

In step S808, the annotation search processing unit 307 makes a list of search results in step S804 and step S807. For example, a list (search result list) of annotation data that includes the text data detected in step S804, and annotation data that includes the annotation data including the attribute information detected in step S807, is created.

(Displaying Target Position Search Result)

FIG. 9 is a flow chart depicting the detailed flow of processing to display the target position search result shown in step S610 in FIG. 6. Now a processing flow to display the search result based on the search result list will be described with reference to FIG. 9. In this embodiment, the diagnostic image is displayed on the display apparatus 103 as the search result, and candidate positions are indicated in the diagnostic image. In other words, an image where candidate positions are indicated in the diagnostic image is displayed as the search result.

In step S901, the display data generation control unit 308 acquires the search result list generated in step S808 from the annotation search processing unit 307.

In step S902, the display data generation control unit 308 calculates the range of the diagnostic image to be displayed on the screen (display range) based on the position information of the annotation data (that is, the position information of the candidate position) included in the acquired search result list. According to this embodiment, if a plurality of candidate positions are detected in the search, a display range (display position and display magnification), to include all the candidate positions, is calculated. In concrete terms, the minimum display range to include all the candidate positions is calculated.

In step S903, the display data generation control unit 308 determines whether the display magnification to display the search result is different from the current display magnification, and whether the display position to display the search result is different from the current display position, in other words, whether the display image data must be updated. Generally it is expected that the display magnification in screening for observing the entire image data comprehensively (about ×5 to ×10), the display magnification for detail observation (×20 to ×40), and the display magnification for confirming the target position search result (magnification calculated in step S902), are different. Therefore the processing in this step is required. If the display image data must be updated, processing advances to step S904. If an update of the display image data is not required, processing advances to step S905.

In step S904, the display image data acquiring unit 309 acquires the diagnostic image corresponding to the display magnification to display the search result (display magnification calculated in step S902) according to the determination result in step S903.

In step S905, the display data generation control unit 308 determines whether the number of candidate positions is greater than a predetermined number. The threshold (predetermined number) used for the determination can be freely set. If the number of candidate positions is greater than the predetermined number, processing advances to step S906, and if the number of candidate positions is the predetermined number or less, processing advances to step S907.

In step S906, the display data generation control unit 308 selects pointer display mode. The pointer display mode is a mode to indicate a candidate position in the diagnostic image using an icon image. Then, based on this selection, the display data generating unit 310 generates pointer display data. The pointer display data is image data where the pointer is located in the candidate position.

In step S907, the display data generation control unit 308 selects an annotation display mode. The annotation display mode is a mode to indicate a candidate position in the diagnostic image using an image of a corresponding annotation (text). Then, based on this selection, the display data generating unit 310 generates annotation display data. The annotation display data is image data where the image of the corresponding annotation is located in the candidate position.

In step S908, the display data generating unit 310 combines the display data generated in step S906 or step S907 (pointer display data or annotation display data) and the diagnostic image data at the display magnification calculated in step S902, so as to generate the display data as the search result. In concrete terms, the image data is generated by superimposing the pointer display image or the annotation display image on the diagnostic image at the display magnification calculated in step S902.

In step S909, the display data output unit 311 outputs the display data generated in step S908 to the display apparatus 103.

In step S910, the display apparatus 103 updates the screen (display image) so that an image based on the display data outputted in step S909 is displayed.

In other words, according to this embodiment, if the number of candidate positions is greater than the predetermined number, the image where the candidate positions are indicated in the diagnostic image using icon images is displayed as the search result. An example of the display image in the pointer display mode will be described later with reference to FIG. 10. If the number of candidate positions is the predetermined number or less, then an image where the candidate positions are indicated in the diagnostic image using an image of the corresponding annotation is displayed as the search result.

If the ratio of the area of the annotation image, with respect to the display area on the screen, is great, the observation of the diagnostic image becomes difficult. By using the above configuration, interference of the image of the annotation with the observation of the diagnostic image can be suppressed. In this embodiment, the display mode is selected according to the number of candidate positions, but a configuration such that the user can select the display mode may be used.

In step S911, the display data generation control unit 308 determines whether the current display mode is the annotation display mode or the pointer display mode. If the current display mode is the pointer display mode, processing advances to step S912. If the current display mode is the annotation display mode, processing advances to step S914.

In step S912, the display data generation control unit 308 determines, based on the information from the user input information acquiring unit 303, whether the user selected the icon (an icon image) displayed on the screen or whether the user moved the mouse cursor onto the icon. If the icon is selected, or if the mouse cursor is moved onto the icon, processing moves to step S913. Otherwise processing ends.

In step S913, the display data generating unit 310 displays the image of the annotation (text) attached to the position of this icon (candidate position) as a popup, according to the determination result in step S912. The popup-displayed annotation image may be deleted (not displayed) if the mouse cursor is away from the pointer, or may be continuously displayed until delete is instructed by the user operation, for example.

By executing the processing in steps S912 and S913, the user can confirm the content of the annotation (content of the comment) in the pointer display mode.

In step S914, the display data generation control unit 308 determines, based on the information from the user input information acquiring unit 303, whether the candidate position indicated in the diagnostic image (the annotation image in this embodiment) is selected. If the candidate position is selected, processing advances to step S915. If the candidate position is not selected, processing ends.

In step S915, according to the determination result in step S914, the display image data acquiring unit 309 selects a diagnostic image data of which magnification is the same as the display magnification when the annotation was attached to the selected candidate position.

In step S916, the display data generating unit 310 generates display data based on the annotation data of the candidate position selected in step S914 and the diagnostic image data selected in step S915. In concrete terms, the display data is generated so that the diagnostic image, to which the annotation is attached, is displayed in the display position and at the display magnification, which were used when the annotation is attached to the candidate position selected in step S914. By performing this processing, an image reproducing the display image when the annotation was attached can be displayed.

In step S917, the display data output unit 311 outputs the display data generated in step S916 to the display apparatus 103. In step S918, the display apparatus 103 updates the display screen (display image) so that the image is displayed based on the display data outputted in step S917.

(Display Image Layout)

FIG. 10A to FIG. 10E are examples of an image (display image) based on the display data generated by the image processing apparatus 102 according to this embodiment.

FIG. 10A is a basic configuration of the layout of the display image to observe a diagnostic image. In the example of FIG. 10A, the display image is an image where an information area 1002, a thumbnail image area 1003, and an observation image display area 1005 are arranged in a general window 1001.

The status of a display and an operation, information on various images, a search image (image used for search setting) and a search result are displayed in the information area 1002.
A thumbnail image of a test object to be observed is displayed in the thumbnail image area 1003. A detailed display area frame 1004, to indicate a currently observing area, is displayed in the thumbnail image area 1003. By displaying the detailed display area frame 1004, the position and the size of the currently observing area (position and size in the thumbnail image, that is, an image for a detailed observation, which will be described later), can be recognized.
An image for detailed observation is displayed in the observation image display area 1005. In concrete terms, a part or all of the areas of the diagnostic image is/are displayed as an image for detailed observation at a set display magnification. The display magnification of the an image for detailed observation is displayed in the section 1006 of the observation image display area 1005. The area of the test object to be observed in detail can be set or updated by a user's instruction via the externally connected input device, such as a touch panel or mouse 411. This setting or update is also possible by moving and zooming in/moving out (changing display magnification) of the currently displayed image.
Each of the above mentioned areas may be created by dividing the display area of the general window 1001 by a single document interface, or each of the areas may be created as mutually different window areas by a multi-document interface.

FIG. 10B is an example of the display image when the annotation is attached. The display magnification is set to ×20 in FIG. 10B. If the user selects a position in the image displayed in the observation image display area 1005, this position is determined as a region of interest, and the annotation is attached to this position. If the user specifies a position using a mouse pointer, for example, the annotation input mode is started, where text input is prompted. If the user inputs text via the keyboard 410, the annotation is attached to the specified position. Then the image processing apparatus 102 acquires information on the position where the annotation is attached and on the display magnification from the display apparatus 103. Attribute information can also be set when the annotation is attached. The reference numeral 1009 denotes an image for setting attribute information, which is an image of a list of attribute information that can be set. If the user selects and specifies a desired attribute information from an attribute information list 1009, the selected attribute information is associated with the annotation to be attached. FIG. 10B shows a state when the mouse cursor is defined in the position 1007, and the text 1008 is input as an annotation.

FIG. 10C is an example of a display image when a target position is searched for (image used for search setting: setting image).

The setting image 1010 may be displayed in the information area 1002 when the target position is searched for, or may be displayed as a new image. In this example it is assumed that the setting image 1010 is displayed in the information area 1002 when an annotation is attached. The present invention is not limited to this configuration, but the setting image 1010 may be displayed when the first annotation is attached during the time of one diagnosis.

The target position is searched for, using a word included in the text of an annotation or attribute information as a search key. Both a word included in the text of an annotation and the attribute information may be used as search keys, or only one may be used as a search key. FIG. 10C is an example where information of four types of attributes: diagnostic information, progression, date and time, and diagnostician, can be set as the attribute information to be the search key, but the types of attributes are not limited to this example.

The user can input a word (keyword) included in the text of an annotation in the text box 1011 as a search key. The user may directly input the keyword. Or a list of keywords used in the past may be displayed in another window or as a dialog, so that the user selects a word to be a search key from this list.

A plurality of radio buttons 1012 correspond to a plurality of attributes respectively. The user selects at least one radio button 1012, whereby the attribute corresponding to the selected radio button can be selected as an attribute of the attribute information to be a search key.

The reference numeral 1014 denotes an area where the attribute information to be the search key is displayed. However, even if the attribute information is displayed in the area 1014, the attribute information is not used as a search key for searching if the radio button corresponding to this attribute is not selected. The attribute information is used as a search key if the attribute information is displayed in the area 1014, and the ratio button corresponding to this attribute is selected.

A selection list button 1013 is a button to display a list of attribute information (choices) of the corresponding attribute. For example, if the user selects the selection list button 1013 corresponding to the diagnostic information, the image 1015 of the list of choices of the diagnostic information is displayed in another window or as a dialog. The image 1015 includes a plurality of radio buttons 1016 corresponding to a plurality of choices. The user can select or change search keys by selecting or changing one or more radio buttons 1016. For example, a search key can be selected from the following radio buttons: “Caution”, to search an area where caution is required; “Normal”, to search a normal area; and “Comparison and Reference”, to search an area for comparison. A search key can be set for progression as well. In concrete terms, a search key can be selected out of a plurality of choices that indicate the degree of progression (progress level) of a disorder in cells or tissues.

If the search key is date and time information, the user may directly input the date and time (e.g. date when annotation is attached, date of diagnosis) in the text box corresponding to the attribute “Date and Time”. A list 1017 of date and time information included in the stored annotation data may be displayed in another window or as a dialog, so that the user selects the date and time to be the search key out of this list. A plurality of dates and times may be used as a search key, or a certain period may be used as a search key.

In the case of using the user information as a search key, the user may directly input a user name or other information in the text box corresponding to the attribute “Diagnostician”. A list of registered users may be displayed in another window or as a dialog, so that the user can select a user to be a search key from the list.

If a key word is input and a search button is selected (“Search” in FIG. 10C), searching is executed using the keyword. If the attribute information is set as a search key (if the radio button 1012 is selected, and corresponding attribute information is set), and the search button is selected, searching is executed using the attribute information as a key.

FIG. 10D is an example of a display image when a search result is displayed in the pointer display mode. When many annotations (comments) are attached, the annotations can be hidden, and only icon images 1018 are displayed in the candidate positions as shown in FIG. 10D, so that the candidate positions can be checked without interfering with display of the diagnostic image. In the case of the example in FIG. 10D, a different icon image is displayed for each attribute information. By this configuration, the relationship of the candidate position and the attribute information can be shown, and a desired position (target position) can be easily detected among a plurality of candidate positions. If an arbitrary icon image is selected, the annotation 1019 is displayed. Thereby the user can check the annotation of the candidate position. A candidate position extracted by searching using the key word, and a candidate position extracted by searching using the attribute information may be indicated by different icon images.

In annotation display mode, the annotation 1019 is disposed in each candidate position. In the annotation display mode, icon images 1018 may or may not be displayed.

FIG. 10E is an example of a display image when a candidate position indicated in the diagnostic image is selected. If a desired candidate position is selected in the annotation display mode or the pointer display mode, the display, when the annotation was attached, is reproduced with reference to the annotation list (to be more specific, the display position and the display magnification of the candidate position included in the annotation data). As a result, the annotation 1020 is displayed in a position on the screen when the annotation was attached. The area of the reproduced display image is displayed in a thumbnail image as a reproduction range 1022, and the area of the diagnostic image, which was displayed when the search result was displayed, is displayed in a thumbnail image as a display frame 1021. Thereby the positional relationship between the reproduced display area and the area of the diagnostic image, which was displayed when the search result was displayed, can be recognized.

### Example of Annotation List

FIG. 11 shows a configuration of an annotation list generated by the image processing apparatus 102 according to this embodiment.

The annotation list is a list of annotation data. Each annotation data has an ID number, which indicates the order of an annotation attachment. As mentioned above, the annotation data includes position information, display magnification, annotation (comment; “annotation content” in FIG. 11), and attribute information or the like, and this information is shown in the annotation list for each ID number. Searching using a keyword is performed targeting the annotation content, and searching using attribute information is performed targeting attribute information. The position information and the display magnification are used to reproduce the display when the annotation was attached. The attribute information may be information on predetermined attributes, or new attributes defined by the user may be additionally set.

(Diagnostic Criterion, Diagnostic Classification, Caution Screen)

FIG. 15A and FIG. 15B show an example of a diagnostic criterion setting screen and an example of a diagnostic classification screen.

FIG. 15A is an example of the diagnostic criterion setting screen. For example, it is assumed that the diagnostic criterion can be changed and set by the operating menu in the general window 1001. The following diagnostic criteria are shown in this window: the cancer classification international code I and the cancer classification international code II which belong to international codes and indexes; the cancer classification Japanese code I and the cancer classification Japanese index I which belong to Japanese codes and indexes; and the cancer classification US index I and the cancer classification US index II which belong to US codes and indexes. The cancer classification Japanese code I is further classified by organ or area: stomach cancer, colon cancer, liver cancer, lung cancer, breast cancer, esophageal cancer, thyroid cancer, bladder cancer, prostate cancer and the like. The operating menu displays the diagnostic criterion 1501, the list of codes and indexes 1502, and the list of codes and indexes for each organ and area 1503 respectively. This example is a case when the user selected the diagnostic criterion, the cancer classification Japanese code I and stomach cancer respectively by the operating menu.

FIG. 15B is an example of the diagnostic classification screen. The diagnostic classification 1504 of stomach cancer in the cancer classification Japanese code I has two major sections: invasion depth and progression. The invasion depth is an index of how much the stomach cancer has reached beyond stomach walls, and is classified into four levels: AI to AIV. AI means that the stomach cancer has remained on the surface of the stomach, and AIV means that the stomach cancer has invaded into other organs, for example. Progression is an index indicating how far the stomach cancer has spread, and is classified into five levels: BI to BV. BI means that the stomach cancer has not spread, and BV means that the stomach cancer has spread to the lymph nodes, for example. In the case of the diagnosis of stomach cancer according to the cancer classification Japanese code I, invasion depth and progression are diagnosed based on such information as a sample image. The diagnostic classification 1504 is displayed in the information area 1002 or another window, and the user can operate the display/non-display as necessary.
The diagnostic criterion and diagnostic classification shown in FIG. 15A and FIG. 15B are appropriately updated, and vary depending on country and region. A diagnostic reference and diagnostic classification are clearly indicated because when a user reviews a sample diagnosed according to an old diagnostic criterion, or checks a sample from another country based on a different diagnostic criterion for research, the user can easily identify which diagnostic criterion was used for the written annotation content as a basis for diagnosis.

### Effect of Embodiment

As described above, according to this embodiment, when an annotation is attached, not only the annotation but also the attribute information that can be used as a search key is stored together. Thereby searching according to various purposes of pathological diagnosis becomes possible, and the user can efficiently detect a target position. As a result, time required for operations can be reduced for the user (pathologist).

Further, according to this example, if many candidate positions are extracted in a search, the relationship of each candidate position and the attribute information is clearly indicated, whereby a desired position (target position) can easily be detected.

### Other Examples of Annotation

In the above embodiment, a case of attaching the comment inputted by the user and related attribute information are attached to the diagnostic image as annotations. However the information to be attached as an annotation is not limited to the information of this embodiment, but any information related to a diagnostic image or a diagnostic operation can be attached as an annotation. For example, if the computer (image processing apparatus) has a function to automatically detect various information to support diagnosis by analysing a diagnostic image (automatic diagnosis software), then an annotation may be automatically generated and attached based on this detection result. In this case as well, the processing to record, search and display the annotation can be performed in the same manner as the above mentioned embodiment.

An example of information that is automatically generated by a computer is information on a lesion area. Now an example of the diagnostic support function of the automatic diagnosis software will be described, and also an example of attaching information on the lesion area acquired by the diagnostic support function to the diagnostic image as an annotation will be described. In order to clarify the difference from the above mentioned embodiment, an annotation that is generated based on the information automatically detected by the diagnosis support function will be referred to as “diagnostic support data” hereinbelow.

(Description on Automatic Detection of a Lesion Area by Diagnostic Support Function, and Example of an Automatic Detection Algorithm)

Diagnostic support is a function to support diagnosis by a pathologist, and an example of diagnostic support is automatic detection of a lesion area of prostate cancer. Prostate cancer has a tendency where the ductal size becomes more uneven as the malignancy becomes higher. By detecting a duct and classifying the structural pattern, the detection of a lesion area and the determination of a malignancy of prostate cancer can be performed automatically. Texture analysis is used to detect a duct, and for example, a local characteristic value in each spatial position is extracted based on the filter operation using a Gabor filter, and a duct area can be detected using the value. To classify a structural pattern, complexity is calculated using a form characteristic value such as a cytoplasm area or a luminal area of a duct, and the calculation result is used as a malignancy index. The lesion area automatically detected by the diagnostic support and lesion information (malignancy determination) constitute the diagnostic support data list.

Another example of diagnostic support is automatic detection of the positive ratio of ER (Estrogen Receptor) of breast cancer. The ER positive ratio is a critical index to determine the treatment plan of breast cancer. If the IHC (immunohistochemical straining) method is used, a nucleus in which ER is strongly recognized is stained dark. Thus the ER positive ratio is determined by automatically detecting the nuclei and staining degree. In this case, the image data clearly indicating the automatically detected nuclei and numeric data (e.g. number of positive nuclei, ratio of positive nuclei) thereof, and the positive ratio constitute the diagnostic support data list.

### Example of Diagnostic Support Data List

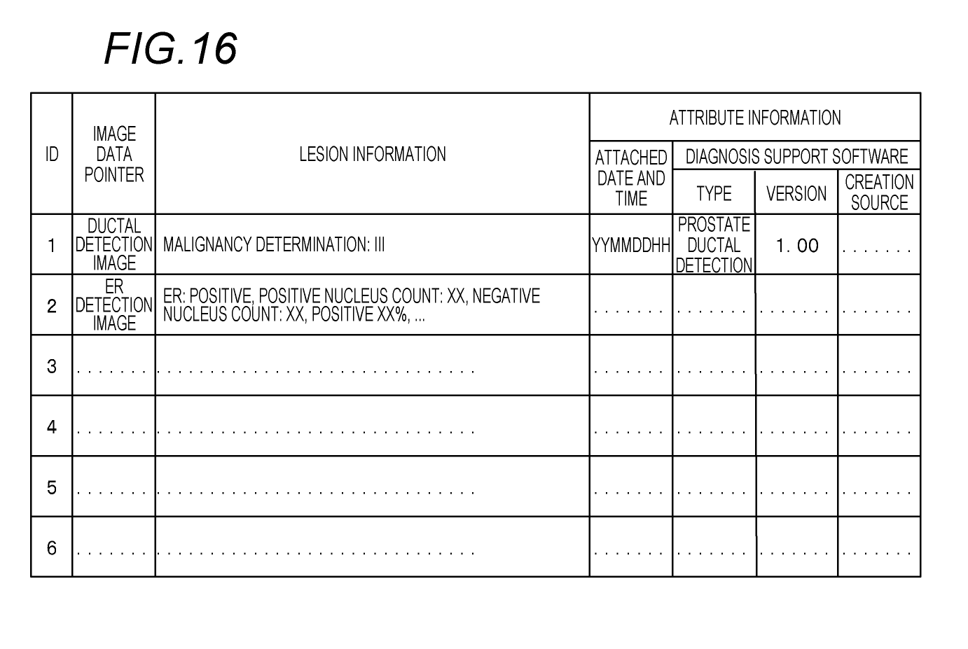

FIG. 16 shows a configuration of the diagnostic support data list generated by the image processing apparatus 102 according to this embodiment.

The data related to the lesion area automatically detected by the diagnostic support function (diagnostic support data) includes image data that indicates the lesion area (diagnostic support image data), therefore the data volume tends to be enormous. This means that a configuration to hold the image data on the lesion area separately from the diagnostic support data list is desirable. In this case, a pointer to point to the image data on lesion area is written (recorded) in the diagnostic support data list. This pointer is information to indicate a position to be paid attention to in the diagnostic image, and is information corresponding to the position information in the annotation data list in FIG. 11. In the diagnostic support data list, the position information on the lesion area in the diagnostic image may be recorded, instead of the pointer.

The diagnostic support data list is a list of diagnostic support data. An ID number, to indicate the order of attaching the diagnostic support data, is assigned to each diagnostic support data. As mentioned above, the diagnostic support data includes the image data pointer and the lesion information, and the diagnostic support data list shows this information according to the ID number. Searching by word is performed targeting the lesion information, and searching using attribute information is performed targeting attribute information. The attribute information is, for example, attached date and time and the type and version of diagnostic support software. The “lesion information” may be the information selected from a predetermined list, just like the case of the “diagnostic information” and “progression” in FIG. 10C (in other words, the lesion information may be included in the attribute information).

(Searching Diagnostic Support Data)

The diagnostic support data can be searched in a method the same as searching for the target position in FIG. 8. FIG. 8 and description thereof can be used here, substituting “annotation” with “diagnostic support data”.

(Displaying Diagnostic Support Data)

The diagnostic support data is displayed as the diagnostic support image data for indicating the lesion area, which is different from display image data. However the image to indicate the lesion area may be superposed onto the display of the display image data, by performing automatic detection of the lesion area in more detail using the diagnostic support function. For example, in the automatic diagnosis of prostate cancer, if malignancy is determined for each area, such as a malignant V area or a malignant IV area, along with the detection of the lesion area, then the malignant V area, for example, can be superposed onto the display image data.

(Effects of Diagnostic Support Data of this Embodiment)

As described above, according to this embodiment, attribute information that can be used as a search key is stored with the lesion information when the diagnostic support data is attached. Therefore a search for various purposes of pathological diagnosis becomes possible, and the user can efficiently detect a target position, such as a lesion area. As a result, the time required for operations can be reduced for the user (pathologist).

### Embodiment 2

Now an image processing system according to Embodiment 2 of the present invention will be described with reference to the drawings.

In Embodiment 1, a diagnostic image where candidate positions are indicated is displayed on the display apparatus as the search result. In Embodiment 2, a list to indicate the attribute information corresponding to each candidate position is created and displayed on the display apparatus as the search result. This makes it easier to recognize the attribute information of the candidate position. If the user selects a candidate position on the list, an image indicating the selected candidate position is displayed on the display apparatus. Thereby the relationship between the candidate position and the attribute information can be easily recognized. Differences from Embodiment 1 will now be described, while minimizing description on configurations and processing that are the same as Embodiment 1.

(Apparatus Configuration of Image Processing System)

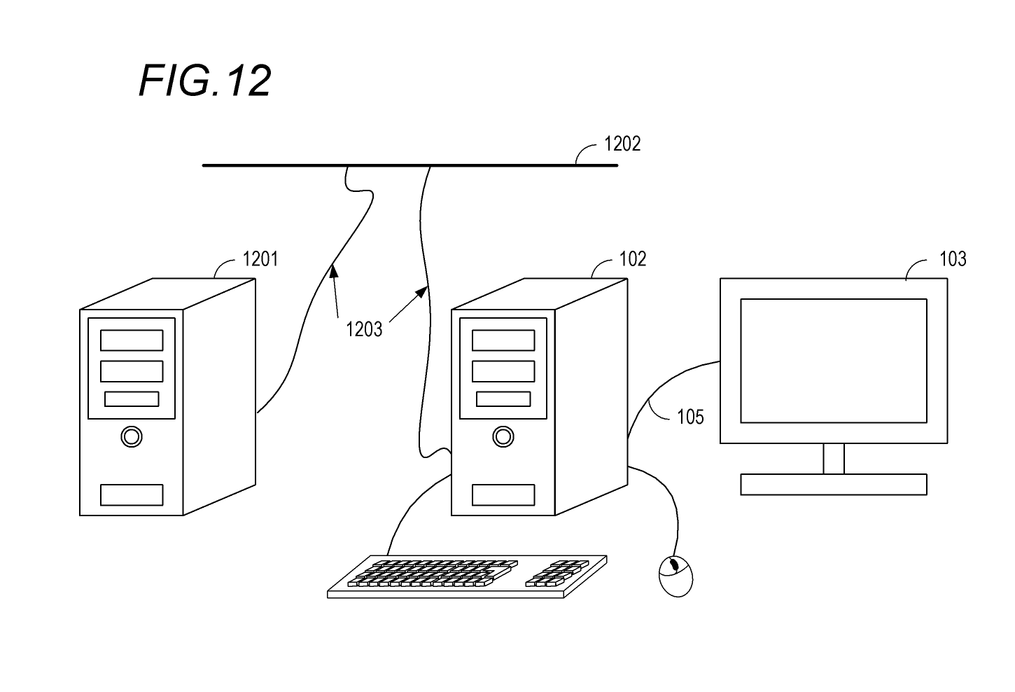

FIG. 12 is a diagram depicting a configuration of the image processing system according to Embodiment 2.

The image processing system according to this embodiment comprises an image server 1201, an image processing apparatus 102 and a display apparatus 103. The image processing apparatus 102 acquires diagnostic image data which was acquired by imaging a test object, and generates display data to be displayed on the display apparatus 103. The image server 1201 and the image processing apparatus 102 are interconnected via a network 1202 using a standard I/F LAN cable 1203. The image server 1201 is a computer having a large capacity storage device for storing diagnostic image data generated by the imaging apparatus 101. In Embodiment 2, a plurality of diagnostic image data, which is on a same test object imaged at mutually different magnification values (a plurality of hierarchical image data), is collectively stored in a local storage connected to the image server 1201.

The diagnostic image data may be stored on a server group (cloud servers) that exist somewhere on the network. For example, the diagnostic image data may be divided into a plurality of divided image data and saved on cloud servers. In this case, information to restore the original data or information to acquire a plurality of diagnostic image data, which is on a same test object imaged at mutually different magnification values, is generated and stored on the image server 1201 as link information. A part of the plurality of diagnostic image data, which is on a same text object imaged at mutually different magnification values, may be stored on a server that is different from the rest of the data.

The general functions of the image processing apparatus 102 are the same as Embodiment 1. The functions of the display apparatus 103 are the same as Embodiment 1.

In the example of FIG. 12, the image processing system is constituted by three apparatuses: the image server 1201; the image processing apparatus 102; and the display apparatus 103, but the configuration of the present invention is not limited to this configuration. For example, the image processing apparatus may be integrated with the display apparatus, or a part or all of the functions of the image processing apparatus 102 may be built in to the image server 1201. The functions of the image server 1201, the image processing apparatus 102 and the display apparatus 103 may be implemented by one apparatus. Instead the functions of one apparatus may be implemented by a plurality of apparatuses. For example, the functions of the image server 1201 may be implemented by a plurality of apparatuses. The functions of the image processing apparatus 102 may be implemented by a plurality of apparatuses.

In Embodiment 1, the image processing apparatus 102 attaches annotations to diagnostic image data captured and outputted by the imaging apparatus 101, and searches the diagnostic image data for a target position. That is, a target position is searched for in a single diagnostic image (here a plurality of hierarchical diagnostic images are regarded as a single diagnostic image). In Embodiment 2 however, annotations are attached to diagnostic images stored in the image server 1201, and a target position is searched for in the diagnostic images stored in the image server 1201. Therefore a target position can be searched for in a plurality of diagnostic images. For example, a target position is searched for in a plurality of diagnostic images acquired from one patient. Thereby the progress of one patient can be observed and a state of a same lesion can be easily compared at various locations. Further, by searching a plurality of diagnostic images for a target position, annotations matching with similar cases and conditions can be easily recognized.

(Displaying Target Position Search Result)

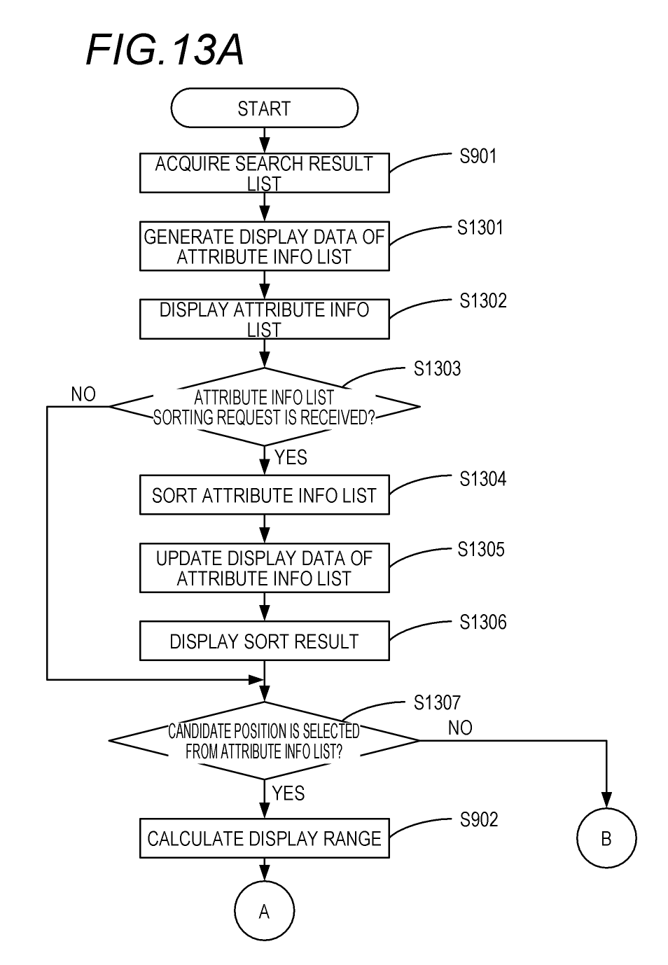

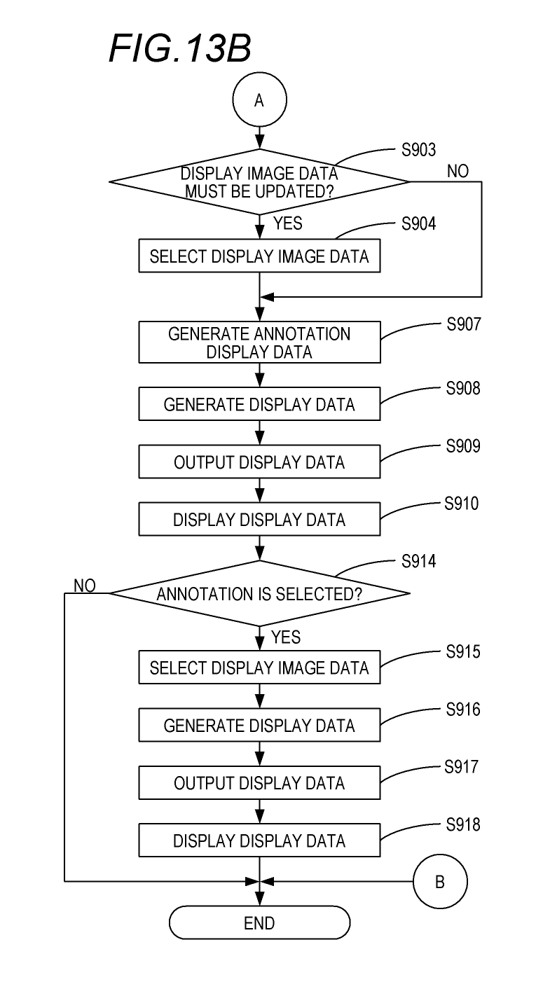

FIG. 13 is a flow chart depicting a flow of processing to display a search result of a target position in step S610 in FIG. 6. In FIG. 13, a flow of displaying candidate positions as a list and displaying a candidate position according to the content of the list selected by the user will be described.

In step S901, the display data generation control unit 308 acquires the search result list generated in step S808 from the annotation search processing unit 307.

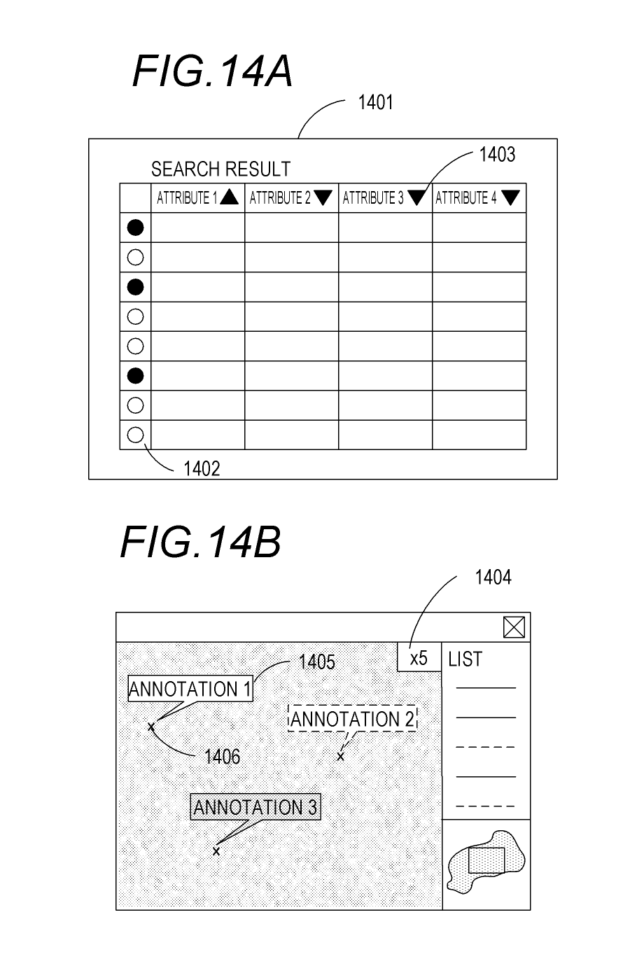

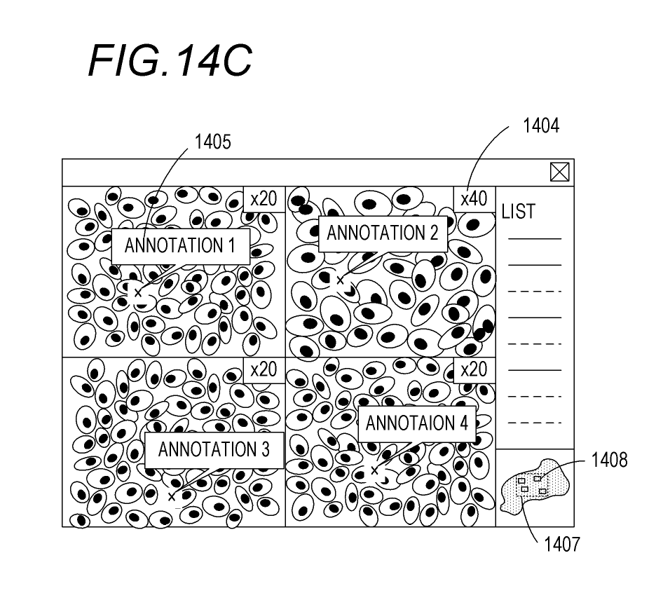

In step S1301, the display data generation control unit 308 generates a list to indicate attribute information corresponding to each candidate position (attribute information list) using the search result list acquired in step S901. The display data generating unit 310 then generates display data including the attribute information list. The display area of the attribute information list is the information area 1002 shown in FIG. 10A, for example. But the display area is not limited to this, but another display area may be set for the attribute information list. The display area of the attribute information list may be an area of an independent window. An example of the display image to display the attribute information list will be described later with reference to FIG. 14A to FIG. 14C.

In step S1302, the display data output unit 311 outputs the display data generated in step S1301 to the display apparatus 103, and the display apparatus 103 displays the display image based on the display data.

In Embodiment 2, the attribute information list is a sortable list.

In step S1303, the display data generation control unit 308 determines whether a request to sort the attribute information list is received, based on the information from the user input information acquiring unit 303. If the sort request is received, processing advances to step S1304. If the sort request is not received, processing advances to step S1307.

In step S1304, the display data generation control unit 308 sorts the attribute information list. For example, the attribute information list is sorted in the sequence of date and time indicated in the date and time information, according to operation by the user. In concrete terms, if the user operates such that the attribute information list is sorted in the sequence of date and time indicated in the date and time information, the display data generation control unit 308 sorts the attribute information according to this operation by selecting an item of date and time in the attribute information list so that the date and time information is listed in ascending or descending order.

In step S1305, the display data generating unit 310 updates the display data so that the attribute information list becomes the attribute information generated after sorting in step S1304.

In step S1306, the display data output unit 311 outputs the display data updated in step S1305 to the display apparatus 103, and the display apparatus 103 displays the display image based on the display data.

In step S1307, based on the information from the user input information acquiring unit 303, the display data generation control unit 308 determines whether the candidate position is selected from the currently displayed attribute information list. One candidate position may be selected, or a plurality of candidate positions may be selected. If any candidate position is selected, processing advances to step S902. If no candidate position is selected, processing ends.

Then the processing in steps S902 to 904 is executed in the same manner as Embodiment 1, and the processing in steps S907 to S910 are executed in the same manner as Embodiment 1, then the processing in steps S914 to S918 is executed in the same manner as Embodiment 1.

(Display Image Layout)

FIG. 14A to FIG. 14C are examples of an image (display image) based on the display data generated by the image processing apparatus 102 according to this embodiment.

FIG. 14A is an example of the attribute information list displayed as the search result. The attribute information list 1401 includes the attribute information for each candidate position. The attribute information list 1401 includes a check box 1402 for selecting a corresponding candidate position from the list, and a sort button 1403 to perform sorting based on the attribute information. The user can select one or a plurality of candidate position(s) by selecting the corresponding check box 1402. If priority among the attribute information is set, a sort operation by a plurality of attribute information becomes possible.

FIG. 14B is an example of the display image when the candidate positions selected using the check box 1402 are displayed in the annotation display mode. Here an example of selecting three candidate positions is shown. In this embodiment, an image 1405, including the display image and annotations (annotations corresponding to the selected candidate positions) is displayed in such a display position and at such a display magnification that all the selected candidate positions are displayed. The annotation image 1405 is displayed in the corresponding candidate position 1406. In the case of the example in FIG. 14B, the diagnostic image and annotation image are displayed at a low display magnification, ×5. The annotation image is displayed in a different form for each attribute information (e.g. display magnification when the annotation was attached). For example, it is assumed that the display magnification was ×10 when the annotation 1 was attached, ×20 when the annotation 2 was attached, and ×40 when the annotation 3 was attached. By changing the method of displaying an annotation image for each display magnification when the annotation was attached, the difference of the display magnification can be recognized. Here the attribute information is distinguished by the type of line used for the display frame of the annotation, but may be distinguished by the color or shape of the display frame.

In this embodiment, when a candidate position is selected using the check box 1402, the selected candidate position is clearly indicated in the annotation display mode, but the selected candidate position may be clearly indicated in the pointer display mode. The display mode may be switched according to the number of candidate positions to be displayed, in the same manner as Embodiment 1.

FIG. 14C is an example of an image which is displayed when a candidate position (annotation image, icon image) shown in the diagnostic image is selected. FIG. 14C is an example when four candidate positions are selected. In FIG. 14C, reproduction similar to FIG. 10E is displayed for each candidate position. The display magnification when the annotations 1, 3 and 4, out of the four annotations 1 to 4 denoted with the reference numeral 1405 are attached, is ×20, and only the display magnification when the annotation 2 is attached is ×40. The display magnification when an annotation is attached to each candidate position can be checked in the display magnification displayed in the area 1404. Instead the difference of display magnifications may be clearly indicated by the color of the frame of the display area of each diagnostic image. The positional relationship between an area of the diagnostic image displayed when the candidate position is selected from the list (e.g. area of diagnostic image displayed in FIG. 14B) and each area that is reproduced and displayed can be determined in the same manner as Embodiment 1. In concrete terms, the area of the diagnostic image that was displayed when the candidate position was selected from the list is displayed as a display frame 1407 in a thumbnail image, and each area that is reproduced and displayed is displayed in the thumbnail image as a reproduction range 1408. The correspondence of the reproduction range 1407 and the image that is reproduced and displayed can be recognized by the color of the frame lines, type of line or the like. By selecting either a plurality of images or a plurality of reproduction ranges that are reproduced and displayed, the display mode, to display an image at the display magnification corresponding to the selected image (reproduction range) on the entire observation image display area, may be started.

### Effects of this Embodiment

As described above, according to this embodiment, attribute information that can be used as a search key is stored with the annotation when the annotation is attached. Therefore a search for various purposes of pathological diagnosis becomes possible, and the user can efficiently detect a target position. As a result, the time required for operations can be reduced for the user (pathologist).

According to this embodiment, a list of attribute information is displayed for each candidate position as a target position search result, and a diagnostic image indicating the candidate position selected from the list is displayed. Thereby the target position search result can be recognized with more specificity.

### Other Embodiments

The object of the present invention may be achieved by the following. That is, a recording medium (or storage medium) recording the software-based recording program codes, which implement all or a part of the functions of the above mentioned embodiments, is supplied to a system or an apparatus. Then a computer (or CPU or MPU) of the system or an apparatus reads and executes the program codes stored in the recording medium. In this case, the program codes read from the recording medium implement the functions of the above mentioned embodiments, and the recording medium recording the program codes constitutes the present invention.

The present invention also includes a case of a computer executing the read program codes, and an operating system (OS) running on the computer, executing a part or all of the actual processing based on instructions of the program codes, whereby the functions of the above mentioned embodiments are implemented.
The present invention also includes a case of program codes read from a recording medium written on a function extension card inserted into a computer or a memory provided in a function extension unit connected to a computer, and a CPU of the function extension card or the function extension unit performing a part of or all of the actual processing based on the instructions of the program codes, whereby the functions of the above mentioned embodiments are implemented.
If the present invention is applied to the recording medium, the program codes corresponding to the above mentioned flow chart are stored in the recording medium. The configurations described in Embodiments 1 and 2 may be combined. For example, the display processing to reproduce a plurality of target positions in Embodiment 2 may be applied to the system in Embodiment 1, or the image processing apparatus may be connected to both the imaging apparatus and the image server, so that images to be used for processing can be acquired from either apparatus. Configurations implemented by combining various techniques described in each embodiment are also within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-283722, filed on Dec. 26, 2011, Japanese Patent Application No. 2011-286782, filed on Dec. 27, 2011, and Japanese Patent Application No. 2012-225979, filed on Oct. 11, 2012, which are hereby incorporated by reference herein in their entirety.

1. An image processing apparatus, comprising:
an attaching unit that attaches an annotation to a diagnostic image acquired by imaging an object;
a recording unit that records, in a storing unit along with an annotation, attribute information which is information on a predetermined attribute, as information related to the annotation;
a searching unit that searches a plurality of positions where annotations are attached respectively in the diagnostic image, for a target position which is a position a user has an interest in; and
a displaying unit that displays the search result by the searching unit on a display,
wherein the searching unit searches for the target position using a word included in the annotation or the attribute information as a key.

2. The image processing apparatus according to claim 1, wherein the attribute information includes diagnostic information that indicates diagnostic content of the diagnostic image.

3. The image processing apparatus according to claim 1, further comprising an automatic diagnosing unit that automatically detects information for supporting diagnosis by analyzing the diagnostic image,
wherein the annotation includes an annotation that is attached based on the detection result by the automatic diagnosing unit.

4. The image processing apparatus according to claim 3, wherein
the annotation attached based on the detection result by the automatic diagnosing unit includes information for supporting the diagnosis as text information, and
the searching unit searches for the target position using a word included in the information for supporting the diagnosis as a key.

5. The image processing apparatus according to claim 1, wherein the attribute information includes information to indicate a diagnostic criterion used for diagnosing the diagnostic image.

6. The image processing apparatus according to claim 1, wherein the attribute information includes date and time information that indicates date and time when the corresponding annotation is attached, or date and time when the diagnostic image is observed.

7. The image processing apparatus according to claim 1, wherein the attribute information includes user information to specify a user who has attached the annotation.

8. The image processing apparatus according to claim 7, wherein
a plurality of users sequentially attach annotations to the diagnostic image with different purposes or with different methods,
the user information includes a user attribute indicating the purpose or method at the time when each of the users attaches the annotation, and
the searching unit searches for the target position using the user attribute as a key.

9. The image processing apparatus according to claim 1, wherein the attribute information is information inputted by the user who has attached the annotation.

10. The image processing apparatus according to claim 1, wherein
the searching unit searches for and detects a candidate position, which is a candidate of the target position, from a plurality of positions where annotations are attached respectively by the attaching unit, and
the displaying unit displays a list of attribute information that corresponds to each candidate position, on the display as the search result.

11. The image processing apparatus according to claim 10, wherein
the attribute information includes date and time information that indicates a date and time when the corresponding annotation is attached or a date and time when the diagnostic image is observed, and
the list of the attribute information can be sorted in the sequence of date and time indicated by the date and time information.

12. The image processing apparatus according to claim 10, wherein, when the user selects a candidate position from the list, the displaying unit displays the diagnostic image on the display, and also presents the selected candidate position in the diagnostic image.

13. The image processing apparatus according to any one of claim 10, wherein, when the user selects a plurality of candidate positions from the list, the displaying unit displays the diagnostic image on the display in such a display position and at such a display magnification that all the selected candidate positions are included, and also presents the selected candidate positions in the diagnostic image.

14. The image processing apparatus according to claim 1, wherein
the searching unit searches for and detects a candidate position, which is a candidate of the target position, from a plurality of positions where an annotation is attached by the attaching unit, and
the displaying unit displays the diagnostic image on the display and also presents the candidate position in the diagnostic image, as the search result.

15. The image processing apparatus according to claim 14, wherein, when the searching unit detects a plurality of candidate positions, the displaying unit displays the diagnostic image on the display in such a display position and at such a display magnification that all the candidate positions are included, and also presents the candidate positions in the diagnostic image.

16. The image processing apparatus according to claim 12, wherein the displaying unit presents the candidate position using a corresponding annotation image.

17. The image processing apparatus according to claim 12, wherein the displaying unit presents the candidate position using an icon image.

18. The image processing apparatus according to claim 12, wherein
when the number of candidate positions to be displayed is a predetermined value or less, the displaying unit presents the candidate positions using corresponding annotation images, and
when the number of candidate positions to be displayed exceeds the predetermined value, the displaying unit presents the candidate positions using icon images.

19. The image processing apparatus according to claim 17, wherein the icon image is different depending on the attribute information.

20. The image processing apparatus according to claim 16, wherein the annotation image is different depending on the attribute information.

21. The image processing apparatus according to claim 14, wherein, when the user selects the presented candidate position, the displaying unit displays the diagnostic image on the display in the display position and at the display magnification that are used when the annotation is attached to the candidate position.

22. The image processing apparatus according to claim 1, wherein the searching unit searches a single diagnostic image for the target position.

23. The image processing apparatus according to claim 1, wherein the searching unit searches a plurality of diagnostic images for the target position.

24. The image processing apparatus according to claim 23, wherein the searching unit searches a plurality of diagnostic images acquired from one patient for the target position.

25. An image processing system, comprising:
the image processing apparatus according to claim 1; and
the display.

26. An image processing method comprising:
an attaching step in which a computer attaches an annotation to a diagnostic image acquired by imaging an object;
a recording step in which the computer records, in a storing unit along with an annotation, attribute information which is information on a predetermined attribute, as information related to the annotation;
a searching step in which the computer searches a plurality of positions where annotations are attached respectively in the diagnostic image, for a target position which is a position a user has an interest in; and
a displaying step in which the computer displays the search result obtained in the searching step on a display,
wherein the target position is searched for in the searching step, using a word included in the annotation or the attribute information as a key.

27. A non-transitory computer readable storage medium storing a program that causes a computer to execute each step of the image processing method according to claim 26.
